(19) United States
(12) Patent Application Publication
(10) Pub. No.: US 2020/0402195 A1
(43) Pub. Date: Dec. 24, 2020

(54) Methods and Systems Using Bets to Describe and Label Information

(71) Applicant: Michael T. Rossides, Scottsdale, AZ (US)

(72) Inventor: Michael T. Rossides, Scottsdale, AZ (US)

(21) Appl. No.: 16/911,077

(22) Filed: Jun. 24, 2020

Related U.S. Application Data
(60) Provisional application No. 62/921,583, filed on Jun. 24, 2019.

(51) Int. Cl. G06Q 50/34; G06Q 20/08; G06Q 20/40; G06F 16/23; G07F 17/32

(52) U.S. Cl. CPC G06Q 50/34; G06Q 20/085; G06Q 20/405; G06Q 40/02; G07F 17/3288; G07F 17/323; G07F 17/3244; G06F 16/2379

(57) ABSTRACT

An online computer database system that enables users to create, match up and settle bets about how experts will characterize or describe specified information. The system displays these bets and bet data, and associates the bet data and statistics with the specified information, thus providing a new way to evaluate, describe and label that information.

### CROSS-REFERENCES TO RELATED APPLICATIONS

This application is preceded by and claims benefit of U.S. provisional patent application 62/921,583, and is related to U.S. utility patent application Ser. No. 11/017,261 (US publication number 20060135250 A1), filed on Jun. 22, 2006, now abandoned, and by disclosure document 529,728, filed on Apr. 15, 2003.

### STATEMENT REGARDING FEDERALLY FUNDED RESEARCH

Not applicable.

### BACKGROUND

### Field of the Invention

The invention relates to peer-to-peer betting systems, betting methods and systems for communicating opinions, and methods and systems for describing information.

### Description of Related Art

A bet is a form of opinion, so any betting market lets users express their opinions. U.S. Pat. Nos. 5,575,474 and 6,443,841 disclose systems for using bets to communicate. Hanson (http://hanson.gmu.edu/gamble.html) has proposed a betting market for scientific opinions.

U.S. patent application Ser. No. 11/017,261 (abandoned) disclosed a system for enabling bets to be made about whether specified statements would be found misleading or fair in the opinion of expert judges, and disclosed processes for using bet information to describe the veracity of specified statements. This current application incorporates the specification of application Ser. No. 11/017,261 by reference and adds new matter. Where that specification used the term subject statement (s-statement), this one will use the more general term subject information (SI).

This current application discloses a system for enabling people to create and use description bets to describe and virtually label SI. It also discloses systems and processes for enabling people to use bet descriptions. The new matter includes but is not limited to processes and features for enabling:
1. A variety of information types to be described.
2. A variety of descriptions of information to be expressed through bets.
3. Information to be conveniently identified so it can be described.
4. Information to be recorded and associated with a bet.
5. Changes in information to be detected and characterized.
6. Description bets to be made easily.
7. Description bets to be viewed easily.
8. Description bets to be used in filtering information.
9. Description bets to be used by web-crawlers, search indexes and search engines to differentiate between and among sets of information.

### OBJECT OF THE INVENTION

An object of the invention is to provide reliable descriptions of information.

### BRIEF SUMMARY OF THE INVENTION

We disclose an online computer database system that enables users to create, match up and settle bets about how experts will characterize or describe specified information. The system displays these bets and bet data, and associates the bet data and statistics with the specified information, thus providing a new way to evaluate, describe and label that information.

### BRIEF DESCRIPTION OF THE DRAWINGS

FIG. 1 shows a bet transaction system for describing and labeling information as an online database and server system.

FIG. 2 shows the modules of the invention.

FIG. 3 shows sub-modules for creating ID-bet terms.

FIG. 4 shows a combination ID-bet authoring form and ID-bet offer form.

FIG. 5 shows an ID-bet authoring form.

FIG. 6 shows an ID-bet authoring form.

FIG. 7 shows a browser with ID-betting functionality, and a combined ID-bet authoring and ID-bet offer form.

FIG. 8 shows an ID-bet terms object related to an ID-bet offer-object.

FIG. 9 shows an abstract representation of an ID-bet market.

FIG. 10 shows a display of search results with ID-bet information.

FIG. 11 shows a flowchart for copying subject information.

FIG. 12 shows a flowchart for copying subject information.

FIG. 13 shows a social media system with ID-betting functionality.

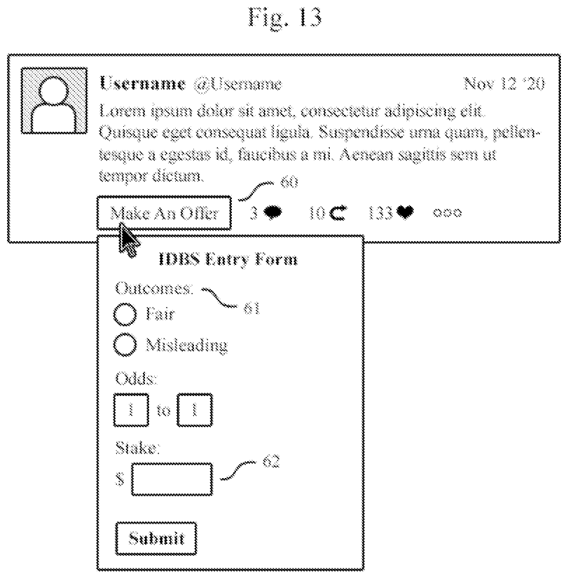

FIG. 14 shows an email system with ID-betting functionality.

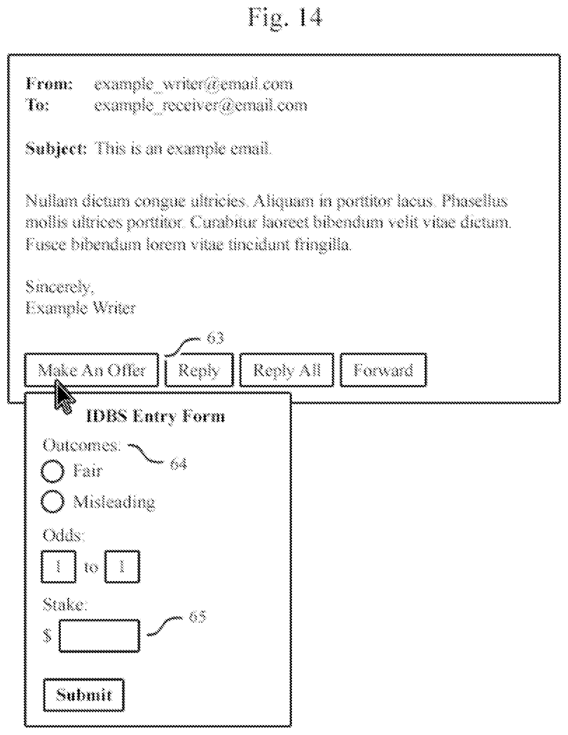

FIG. 15 shows a flow diagram of an information filtering system using ID-bet information.

FIG. 16 shows a flow diagram of an information filtering system using ID-bet information.

FIG. 17 shows the components of search engine system.

### DETAILED DESCRIPTION OF THE INVENTION

### Contents

Why a Bet Transaction System for Describing and Labeling Information?

Specification Describes Modules of the Invention

Most of the Invention's Functions Cannot Be Performed by Humans

Invention Incorporates Known Bet Forms and Betting Methods

Novel Information Interfaces, Objects, and Creations

Initial Definitions

Part 1: Bet Transaction System for Describing and Labeling Information

Bet Transaction System

Hardware Elements

Software Elements

1.1 Module for Authoring the Terms of an ID-Bet and Storing an ID-bet Object

1.2. Module for Searching and Outputting IDBO Information

1.3 Module for Making an ID-Bet Offer, Creating an Offer-Object, Creating ID-Bet Data, and Creating a Virtual Label for SI

1.4. Module for Matching ID-Bet Offers

1.5. Module for Judging and Settling ID-Bets

1.6. Module for Finding and Outputting ID-Bet Data and ID-Bet Market Statistics

1.7. Module for Combining ID-Bet Markets

Part 2: Modules for Describing Bettors and Speakers

Part 3: Modules for Recording Subject Information

Part 4: Modules for Reacting to Changes in Subject Information

Part 5: Module for Safety

Part 6: Browser with ID-Betting Functionality

Part 7: Social Media and Content Management System with ID-Betting Functionality

Part 8: Word Processor with ID-Betting Functionality

Part 9: Email Sending Device with ID-Betting Functionality

Part 10: Information Screening Devices That Interact with the System

Part 11: Search Engine Components That Interact with the System

Claims

Abstract

### INTRODUCTION

### Why a Bet Transaction System for Describing and Labeling Information?

How and why do we trust information, be it the label on a bottle of vitamins, a chart of wind speeds off Aruba, instructions for installing a sink, a headline in an ad about a mutual fund, a documentary on the abuse of pigs, a link in an email, or software for protecting a computer?

Beyond trust, how do we know anything reliably about a piece of information? For instance, how do we know where a fact originated, whether a download of computer code is malicious, or if a book is well written? A piece of information may be described, but how do we know if the description is accurate?

This specification discloses a new tool, an online transaction system that enables people to use bets and betting markets to create meta-information—betting data—that describes subject information. The betting data about a defined set of subject information can provide useful descriptions of that information. It can be used to virtually label that information.

This specification is an enlargement of U.S. patent application Ser. No. 11/017,261, now abandoned, which disclosed a betting method and system for describing statements as misleading or fair. This specification discloses features that enable more descriptions (bet data) to be made about more types of information, and discloses features for making the bet data descriptions and statistics more useful, and easier to create and use.

The inventive system disclosed here is a tool, like an electronic stock price display system, a racetrack totalizator, or a voting machine. It enables people and computers to convert “money votes” into novel, useful, and displayable information entities and creations. The invention can also be cast as a method that directs an online computer database system.

### Specification Describes Modules of the Invention

This specification is divided into descriptions of modules of the invention. A module comprises a process or processes for accomplishing a sub-objective or sub-objectives of the invention. In this specification, a module is generally named for its purpose, and is a high-level description. That is, it is a set of steps, performed by the inventive system, that are grouped together, and that have the same ultimate purpose or related purposes.

Thus, a module that executes the following steps, or the system includes a module that executes the following steps, will refer to software code that operates in a system of machines, and directs the system to accomplish a task or purpose or object or sub-task, sub-purpose, or sub-object of the invention. Rather than say that a module executes steps, this specification will usually say that the system executes steps, and the collection of these steps is also referred to as a module.

Modules operate in a machine, causing physical changes in that machine. So, the modules in combination with the machine are concrete features of the system, like a mast and rudder are parts of a sailboat.

The modules can be decomposed and rearranged, as is apparent to those skilled in the art. The goal of this specification is to disclose a novel system, operated using novel processes, and novel combinations of processes. There is no ideal way to present these processes, therefore those skilled in the art will see better ways to present this disclosure.

Some of the modules disclosed can be services that the inventive system communicates with. For example, modules are disclosed for copying subject information that bets are about. This copying functionality could be a service on a separate machine which the core system invokes. Most systems on the Internet are a combination of services that perform as a system. In practice, the inventive system will likely operate in this manner.

System Modules and Other Components that Execute Steps can be Cast as Methods

This specification describes modules and functions and software/hardware combinations as components of the inventive system. Where these components execute steps, they can also be described as methods for operating an online data base system. Thus, when the specification states that a feature executes specified steps, that phrasing, for purposes of describing and claiming the invention, can be stated as “a method for operating an online database system comprising the following steps.”

### Most of the Invention's Functions Cannot be Performed by Humans

The invention is an online bet transaction and information system, like a totalizator or an electronic stock market system. While humans can transact bets, most of the functions of the inventive system can't be performed by humans. Humans can't communicate at near real-time over a computer network, can't receive information directly from computers over an electronic network, can't send information to any Internet connected computing entity, can't record pages on the Internet, can't follow links across the Internet, can't provide links to other computers over the Internet, can't associate a specified piece of information on the Internet with a dynamic bet record stored in a computer, can't communicate a bet record to any Internet connected computer that requests it. The functions that the system performs and the speed it performs them are impossible for humans to replicate “with pencil and paper.” The invention is a high-speed, online, information processing system which records, manipulates, calculates, and communicates information, creating new, useful information, and communicating that new information to other computers, via electronic networks.

### Invention Incorporates Known Bet Forms and Betting Methods

Bets can be constructed with an endless variety of particular rules. The inventive method and system are not limited to any particular bet form; they can incorporate any suitable form. The novelty of the invention centers on making it easy for people to offer and transact bets that are about specified information, and on generating useful information from such bets.

The principle is that a bettor makes a bet offer that can be matched up against an offer(s) made by opposing bettor(s).

A betting system of the type described here can also enable a user to make a binding bet offer such that the user cannot retract the offer, or can retract the offer and pay a penalty, possibly to another user. This kind of binding offer was described in U.S. Pat. Nos. 5,575,474 and 6,443,841. Those patents also described range bets and profit margin bets and a variety of other bet forms and features that are designed to elicit honest probability estimates. All these bet forms, and the elements for enabling these bet forms are incorporated by reference.

### Peer-to-Peer Betting System

The inventive system is a peer-to-peer betting system. These systems are well known as in, for example, betfair.com and hsx.com. The inventive system is different than conventional peer-to-peer systems because it enables users to set the key terms, or at least one key term, of the bets that are entered, stored, and transacted. Such a system was disclosed in U.S. Pat. Nos. 5,575,474 and 6,443,841. Therefore, it seems pointless to re-disclose certain well-known features of peer-to-peer betting systems. The inventive system is a peer-to-peer betting system with novel features. In theory, it should only be necessary to disclose these features. And, in the claims, the inventive features will indeed be claimed this way. However, to mitigate potential controversy, and to better explain the novelty of the overall system, and the features it contains, this specification describes main features that are well known, especially regarding the making of bet offers and the transacting of bets.

### Standardized Aspects of Bets in Practice

The invention enables bettors to create custom bet terms and offers. In practice, most of the rules and terms of bets enabled by the invention will be held standard. However, for the purpose of attempting to disclose the variety of possible configurations of the invention, this specification will describe how the invention can include features that enable users to set most of the key the terms and rules of bets stored in the system.

### Novel Information Interfaces, Objects and Creations

What makes the inventive system novel are the distinctive sets of bet information that it intakes, processes, creates, transforms, and serves. Thus, novel aspects of the system include bet creation forms it provides to users, bet information it inputs, bet information it generates, bet information it outputs, bet subject information (or representations of subject information) it inputs, bet data (including statistics) it associates with subject information, and bet data (including statistics) it serves to users.

Accordingly, this specification will describe novel combinations of information that the system inputs, generates, and outputs. And, this specification will describe software elements the system includes to enable novel combinations of bet data to be inputted, stored, processed, produced and served. Novelty is not limited by these remarks.

This specification will not include much material regarding well known processes for transacting bets, such as processes for accepting and matching bet offers. The point is to describe and disclose new matter. For clarity and to provide a disclosure that can be practiced, this specification will briefly describe certain processes that are well known but essential in a bet transaction system.

Examples given are illustrative and don't limit the range of applications of the invention.

### Initial Definitions

The definitions below will be elaborated upon throughout this specification and new ones added. The definitions are guides, for many of the concepts elude short definition. Hence, the definitions do not strictly limit the meaning of the terms; where context calls for it, common understandings will apply.

Before the definitions particular to the invention, brief definitions of common computer terms are provided, not to limit those terms, but instead to state affirmatively that operations performed by the system are concrete, physical, and tied to machines—the operations, with certain exceptions, can't be done by humans.

### General, Commonly Understood Definitions

Store means to write information to a database which places it ultimately in a physical medium, such as a flash drive, housed in a data center on the Internet. Store a piece of information can mean store a pointer to that information. A definition and concrete examples of store can be found here: https://en.wikipedia.org/wiki/Computer_data_storage.

Enter means that a computer receives information and stores that information. When a user enters information into a computer, it means the user provides information to the computer via an interface or a computing entity providing information via an API.

Record information means that a computer stores information. It can also mean that a computer finds and copies a set of information and stores it.

Link. A link is a file location or a reference or pointer to information on the Internet.

Respond to a request means that a computing entity has received instructions from another computer or from itself and performs some function, such as retrieving some information.

Input means that a computer receives information and stores it. In the context of the invention, input will mean receiving information over a computer network from another computer, which can be directed by a human user or by a computer program.

Input form means functionality that enables a user or computer to enter information into the inventive system. It encompasses web forms, voice input means, and application programming interfaces for inputting information.

Output. Output means taking information, ultimately stored in a physical medium, from a database, and sending it, over an electronic network, the Internet, to a computer with audio and/or visual output means for human users to receive, or sending it to another computing entity on the Internet. When this specification says that the system outputs information to a user, it means that the system outputs information, over the Internet, to an Internet-connected device that the user employs to receive it. See also:

https://en.wikipedia.org/wiki/Input/output.

Parse information in this specification means any process by which code—a program or protocol—(1) analyzes a set of information, such as a webpage, or an email, a block of text, a bet object, or any structured data or data object, and (2) records (copies, captures, extracts) specified information from the analyzed information or object. The parser can be a program for analyzing and capturing information or it can be a protocol that can analyzes structured information and transmits the analysis or captured information via an API. A parser means the software module, code, or API that performs the parsing.

### Definitions More Particular to the Invention

Information (Info). Information cannot be well defined here. In this specification, it encompasses text, audio, photos, video, software (computer code), music, maps, drawings, formulas, theorems, algorithms, genetic codes, public speaking, conversations, and messages of all kinds. In this specification, info will usually mean something that is identifiable with a “beginning” and an “end” or a “shape” or definable “boundaries”—something that conveys meaning and that people can point to and agree upon what it is, for example, a particular advertisement. Info is something that people or machines can often make a copy of.

Specified Information, Identified Information, Specified Set of Information, and Specified Piece of Information. These terms are used as synonyms to mean any information that has been described such that people can agree on what it is, as in a defined message or demarcated code, as discussed above. So, this specification will refer to methods of identifying and/or referring to a specified “set” or “piece” or “segment” or “object” or “chunk,” or other equivalent, identifiable instance of information. Different types of information have different “boundaries” and “specifiers;” for instance, a sentence has a beginning and end, a paper label on a bottle has a border, a recording of a song has a duration. Identifying specified info uniquely can be tricky or impractical if many similar versions of the info exist.

Excerpt. An excerpt means a specified sub-set of a set of information, as in a string of text out of a longer string of text. Excerpt refers to more than just text, though; an excerpt is a specified part of a larger piece of information.

Location of information. The location of information means where it can be found. Examples: at a Uniform Resource Identifier (URI), at a Uniform Resource Locator (URL), in a database identified by a primary key or set of numbers or a name, at a virtual location defined by search parameters entered into a search engine, at a physical real world “address” (say, the street address of a billboard, or on a certain page of a specific edition of a physical book). Information is stored, or held in, and displayed, or output, by a physical medium, which in some cases can be identified as a location as well. Location can be a pointer to information held in a machine. A location may be a partial location, that is, partial information necessary to find a piece of info.

Information at a time. Information is temporal, existing in a particular time period. So, time is another way information can be identified and specified. Information can be identified by a location and a time, for example, a speech given by a candidate at a specific place and time.

Information identifier is a label, tag, key, or piece of info that is associated with another piece of info, enabling it to be found. An info location, e.g., a URL, can be an info identifier.

Bet, bet offer, bet price, bet contract. Bet can refer to different things. It can refer to a bet offer or a bet agreement. A bet offer defines an event that has not yet taken place, and specifies rules for exchanging money between two or more parties who pick different outcomes for the event, and transfer the money based on which outcome takes place. That is, a bet offer is made by one party to one or more other parties who agree to exchange money depending on the outcome. A bet offer from one bettor can be accepted or matched by an offer from one or more opposing bettors, who have chosen a different outcome from the first bettor. A bet offer also involves rules for dividing the money risked based on the outcome. A bet offer will include a price, the amount of money a person will risk on an outcome happening in exchange for another amount of money offered by a bettor who has chosen a different outcome. The price can be expressed in different ways, for example, as odds. A bet offer can include a commitment to not retract the offer. Bet offers that are accepted or matched constitute a bet agreement between or among two or more bettors. Thus, a bet can also be a contract. In common parlance, to make a bet or place a bet often refers to risking money in a bet contract. But, in this specification, making a bet is a process that has many parts. Bet can refer to any stage of this process from the creation of the terms of a bet, to a bet offer, to the settlement of a bet agreement. So, while the specification will differentiate between different meanings of bet, it will also let the context determine the meaning.

Bet event is the event whose outcomes the bet is about. An event will have two or more possible outcomes. The outcomes of the event determine who wins and loses a bet and how money is transferred between or among opposing bettors.

Bet question is another way of saying a bet event; the question defines the event and a set of outcomes. For example, “Which team will win tonight, the Cavaliers or the Warriors?” In this example, the event is a basketball game with two outcomes. Or, “Who will win the U.S. Men's Tennis Open in 2019?” In this example, the event has many possible outcomes.

Bet Outcomes are the possible outcomes of a bet event.

Bet Terms (Terms of a Bet, Terms). Bet terms are the rules that define and govern a bet, the terms of a bet offer and contract, including how money is to be paid to bettors upon the outcome being determined. Bet terms specify an event, the outcomes, and the rules for transferring money between/among bettors.

Bet Rules are part of the terms of a bet that define how bet offers are made, how they are accepted or matched, how a bet is judged, and how money is transferred from one party to another. Bet rules are not limited to these rules but, like any contract rules, can be extensive.

Bet Object refers, at minimum, to the collection (ensemble) of types of information that comprise the terms of a bet. This ensemble is stored in a database system. Thus, a bet object can also include data and functions. A bet object can specify an event, the outcomes, means for finding the object in the database, and the bet rules. A bet object may also include machine rules (code) for implementing the bet rules, including functions (logic means) for matching up bet offers and enabling bet offer acceptances, and operationalized rules (logic means) for determining the outcome of the bet, and for transferring money between/among bettors as stipulated by the rules. This functional logic operates on the data in a bet object. The functional logic may be outside the object. The bet object is a conceptual idea that is made concrete within the inventive system's database—it is an information ensemble. In addition to containing the terms of a bet, the object can contain information that describes the evolution of actions pertaining to a bet, the bet offers, the amounts of money committed on the outcomes of the bet, whether the bet has been judged, and so forth. A bet has stages, from the creation of the bet terms to the risking of money, to the triggering of judging, to the judging of the outcome, to the settling of the bet and distribution of the money risked by all bettors. The information stored in a bet object can reflect each stage in the evolution of a bet.

Information-Describing Bet (ID-Bet) is a bet about specified information called subject information. Each possible outcome of the bet describes this information. Users making bet offers about the subject information provide bet offer data, which describes the information.

Subject Information (SI) is the subject of an ID-bet, what the ID-bet event and question is about. Subject information must be specified information (see above).

ID-Bet Event, ID-Bet Question. An ID-bet event is the event an ID-bet is about. An ID-bet question is a question that is asked in a bet about the subject information. The answer to the question is the outcome of the event. For example, Will the subject information be found misleading or fair, in the opinion of a judge? In other words, the ID-bet question defines an event and a set of outcomes that a judge or judges can choose from to answer the question. In this example, there are least two outcomes, Misleading and Fair. An ID-bet question can define any number of outcomes.

ID-Bet Terms and Rules define and govern the transaction of an ID-bet from the creation of the ID-bet question and the ID-bet outcomes, to the making of an ID-bet offer, to the acceptance or matching of an offer, to the decision of an ID-bet outcome, to the transfer of money between or among bettors.

ID-Bet Object (IDBO) is the collection of information that comprises the terms and rules of an ID-bet. This collection is stored in a database as a data object. See Bet Object above.

ID Bet Offer is an offer from a bettor to wager money on one of the outcomes of an ID-bet, and to win or lose money from one of more other bettors who have picked another outcome. The offer is made according to the rules/terms of the bet.

ID-Bet Offer-object (Offer-Object) is the collection of information that comprises a bettor's offer to stake money according to the terms of an ID-bet. This collection is stored in a database as a data object. The offer-object can contain more information than just the information entered by a bettor. An offer-object is associated with a corresponding ID-bet object, which defines the terms of the bet.

ID-Bet Agreement is an agreement between two or more parties who have made opposing bet offers that have been matched according to the rules of an ID-bet.

System Administrator (Admin) is a system-authorized user who establishes the conventions of the system, such as the standard betting rules. The admin may also assist other users, such as authors and judges, in inputting data. An admin may also be a bet author who sets some or all of the terms of an ID-bet. An admin may set most of the terms of ID-bets standard, allowing other bet authors, who are public users, to set the rest of the terms.

ID-Bet Author (or Creator) is a user who creates some or all of the terms of an ID-bet.

Public Author is a person who creates some or all of the terms of an ID-bet and is not a system administrator.

Admin Author is a person who creates some or all of the terms of an ID-bet and is an admin.

Bettor is a person who risks money in a bet.

Bet Judge is a system-authorized user who determines the outcome of a bet question. In some cases, a judge can be an automated process, such as an AI.

Viewer is a user who views an ID-bet at any stage from the creation of an ID-bet question to settlement of a ID-bet agreement.

Judge Finder is a system-authorized user who selects judges.

Transmitter means, in most cases, a machine that produces, outputs, or sends information. This specification refers to transmitter as a machine to distinguish it from a human creator or source or sender of information.

Receiver. A receiver is, generally, a machine that receives information to be stored or output. This specification refers to receiver as a machine to distinguish it from a human recipient or consumer of information.

Source is a person or machine who creates or distributes or contributes to information. Source can also mean a specified set of information that has been cited as contributing to the creation of information that is the subject of an ID-bet. It can also mean a person or organization or other party who can vouch for, or testify about, information that is the subject of an ID-bet. Given its multiple, related meanings, context will determine the meaning of source in this specification.

Sender is a person or machine who/that sends information.

Speaker or Information Creator is, generally, a person who creates or distributes information. A speaker can be a machine.

Recipient or Consumer is a person who receives or consumes information. A recipient or consumer can be a machine.

User Bet Record (UBR) is information that is a record of all the elements of a user's bet offer, and a user's actions regarding the offer, and the associated bet object, including the user's result in the bet. The system stores and updates UBR's in its database.

ID-Bet Market and ID-Bet Market Record (Market Record). The ID-bet market is the collection of all the bet offers made by bettors on a particular ID-bet event, including unmatched and matched offers, and further, all the market-affecting actions the system takes at the various stages of the ID-bet, such as the settling of the ID-bet. This market record thus reflects the actions and state of the ID-bet market. It is all the information the system records about the actions of bettors who wager on an ID-bet event. A market record is analyzed by system software to generate useful statistics, called market statistics.

ID-Bet Data encompasses the ID-bet market and market statistics. It refers to any information the inventive system registers, records, processes, and generates from the users regarding a particular ID-bet event. In particular, ID-bet data will usually refer to market statistics the system generates to describe information that is the subject of an ID-bet.

ID-Bet System (IDBS) is an abbreviation for the inventive system. As noted, the invention can also be cast as a set of processes in combination for operating an online database system for the purpose of describing and labeling information.

### Part 1

### 1.0 Bet Transaction System for Describing and Labeling Information

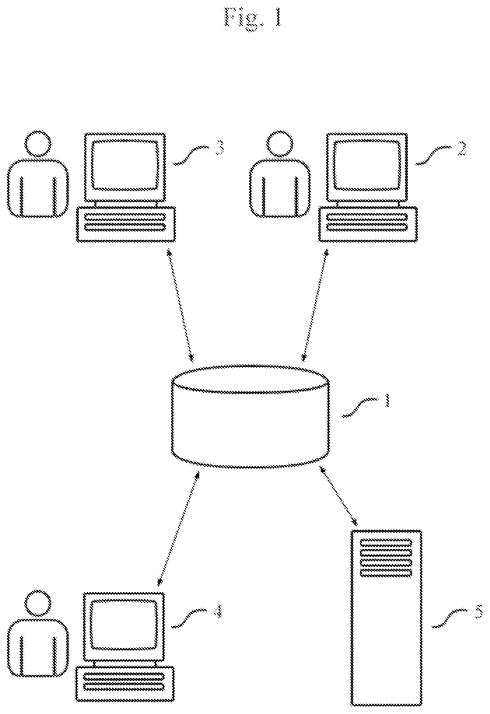

As shown in FIG. 1, the inventive system is an online bet transaction system for describing and labeling information 1, which is an online database and server system that inputs information from bettor terminals 2 and distributes stored and processed information to bettor terminals 3, and to viewer terminals 4, and to online computing entities 5.

Labeling, in this context, means virtually labeling information.

For brevity, the inventive system will be called the ID-Bet System (IDBS).

### Hardware Elements of the Invention

The invention includes the hardware elements that comprise an online computer database system and online transaction server system:
Calculation/logic means for operating on information.
Memory/storage means for recording information.
Input/output means for getting information into and out of the system.
Terminals (or equivalent interface means, which can include voice interfaces) for enabling human users to input and output information.
Communication transmission means (wires and/or wireless components) for enabling the database to communicate with (send information to and receive information from) terminals, users, and other computing entities over the Internet.

### Information Input Means

For the sake of concreteness, Part 1 of this specification mainly uses a web form as the illustrative example of input means that the IDBS presents to human users. The IDBS can include equivalent APIs for enabling computers to input information.

Associating Objects with Each Other in the Database

In multiple places, this specification states that a piece of information or a data object is associated with another or is linked with another. Those skilled in the art will know of many equivalent ways to link sets of information, and so the concept of associates will be meant generally. The implementation of associates and relates and links and matches are not to be limited by the illustrations given.

### Software Elements (Modules) of the Invention

The present invention includes software, also called software means, logic means, or code for creating the processes and features that accomplish the objects of the invention. In this specification, software module or module will mean code that instructs the system to execute operations for accomplishing a named or described task of the invention. For example, the invention includes a module for enabling a user to author the terms of an ID-bet.

A module may be comprised of sub-modules that instruct the system to accomplish sub-objects of a larger object. For example, the module for authoring the terms of an ID-bet will include a sub-module for specifying the subject information that the ID-bet is about.

Modules and sub-modules can be considered the same thing, as they are code operating on machines. This specification names the modules for the convenience of the description. Those skilled in the art will see better ways to name that code and to describe its operation.

The invention includes:
Software (programs) for structuring, organizing, manipulating and operating on the stored information, and creating new information from the stored information.
Database means—software for storing, organizing, and retrieving information.

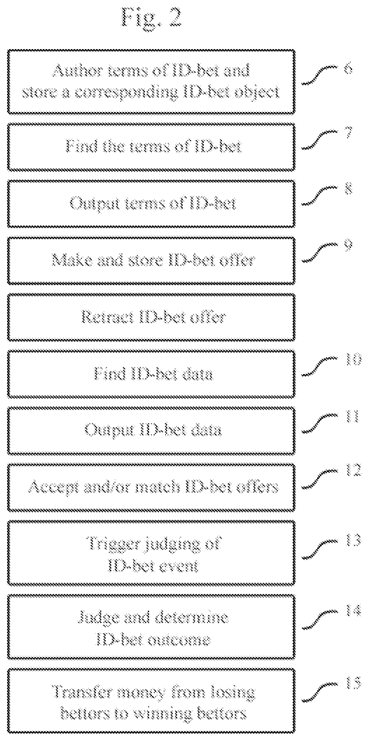

More specifically, as shown in FIG. 2, the invention includes modules for:
Authoring the terms of an ID-bet and storing a corresponding bet object 6
Finding the terms of an ID-bet (that is, finding a bet object) 7
Outputting the terms of an ID-bet 8
Making and storing an ID-bet offer 9
Retracting an ID-bet offer
Finding ID-bet data 10
Outputting ID-bet data 11
Accepting and/or matching ID-bet offers 12
Triggering the judging of an ID-bet event 13
Judging and determining an ID-bet outcome 14
Transferring money from losing bettors to winning bettors 15

For brevity, this stack of modules will be described as 6 modules, with certain functions above combined. The IDBS will include modules for:

1. Creating an ID-bet's terms and a corresponding IDBO
2. Finding and outputting an IDBO
3. Making an ID-bet offer and creating ID-bet data
4. Matching ID-bet offers
5. Judging and settling an ID-bet and transferring money to winning bettors
6. Finding and outputting ID-bet data

### 1.1 Module for Authoring the Terms of an ID-Bet and Storing an ID-Bet Object

The IDBS includes a module that enables users to author the terms of an ID-bet, so other users can find the terms, and make and transact bet offers according to those terms.

This module presents a user with input means, an input form or the equivalent, for entering the terms, which the IDBS stores as an ensemble called an ID-bet object (IDBO).

This specification will divide the authoring module into sub-modules for entering/specifying each term, e.g., a sub-module for identifying the subject information (SI) of an ID-bet. In practice, the sub-modules may not be separate; the entry of all the terms may be handled by the same input form and input process. How the code is written depends on implementation.

In theory, bet terms can have infinite variety, as one could have infinite flexibility in writing a contract. In practice, an IDBS will likely hold almost all terms standard, while enabling authors to customize certain ones. An actual ID-bet IDBS deployed at www.betbacked.com enables authors to create/complete the set of ID-bet terms by entering just one term: a URL that identifies the subject information to be bet about. The other terms are standard.

### Bet Transaction Terms and Rules are Numerous in Practice

Any bet offer, agreement, and transaction is governed by a large number of rules, for example, rules specifying how bettor offers are accepted/matched, how money is committed, how judging is triggered, how offers can be retracted, and so forth. The IDBS will include logic means, code, for operationalizing the rules necessary for transacting a bet. For example, if the payoff rules include a rule that a bet is even odds, 1-1, the system will include logic means for transferring $1 from losing bettors to winning bettors, for each $1 risked by winning bettors whose offers have been matched.

The invention can incorporate a wide variety of bet transaction processes that are well known in the art. This specification mostly omits rules and details that are well known.

### Key Terms of an ID-Bet

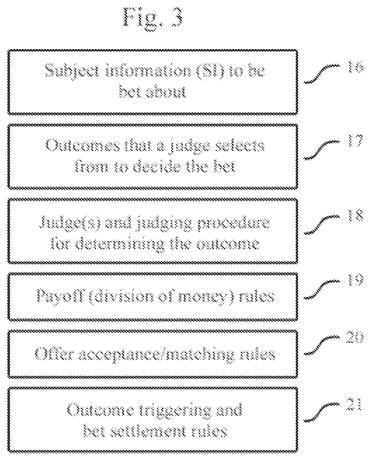

As shown in FIG. 3, to enable an ID-bet author to create ID-bet terms, the authoring module can be visualized as set of sub-modules, each enabling an author to enter a different type of terms information, which the system stores in the ID-bet object:

1. Subject information (SI) to be bet about 16.
2. Outcomes that a judge selects from to decide the bet 17.
3. Judge(s) and judging procedure for determining the outcome 18.
4. Payoff (division of money) rules 19.
5. Offer acceptance/matching rules 20.
6. Outcome triggering and bet settlement rules 21.

All these terms are not necessarily stored in an IDBO. If a term is standard or is a default, the system may store a class signifier in the IDBO to denote the default. Or the system may not store a term at all, if the system applies the term across a class of ID-bets.

These six sub-modules above are described below. They are operationalized by interface and storage means that allow users to enter information, which the system stores, and by system code that executes the terms and rules, according to the information entered by users.

The processes are grouped to simplify the disclosure. In practice, these processes will be composed of many sub-processes in a manner that will depend upon the implementation.

### Functionality for Inputting ID-Bet Terms

The IDBS includes input form functionality for enabling users to enter ID-bet terms, such as a web form with fields and selection options for specifying the different terms of an ID-bet.

The IDBS can also include equivalent voice input means, which can be useful as a speaker talking may want to make an ID-bet on the spot about a statement she is making.

The IDBS can also include application programming interface (API) means for enabling computing entities to enter/submit ID-bet terms.

### Enabling an Author to Name an ID-Bet

Beyond enabling an author to enter the terms, the authoring input form can include a field for naming an ID-bet. The system stores this name as an identifier for finding the IDBO.

### The IDBS May Enable Public Authors to Specify Only Certain Key Terms; System Administrator Authors May Set Some or Virtually all of the Terms

As noted, in practice, many terms of an ID-bet will be held standard. These terms are set by system administrator (admin) authors. In cases of standard terms, the IDBS will not present the corresponding term-entry sub-modules to public authors.

However, admin authors are not the same as public authors because when admin authors create standard terms, those terms apply to classes of bets, while public authors create terms for individual ID-bets.

An ID-bet class is a set of ID-bets that share common terms and rules.

So, the sub-modules for creating ID-bet terms, for use by admin authors, are different from the sub-modules used by public authors. The sub-modules for admin authors will store the terms to apply to classes of ID-bets and to classes of associated IDBOs.

Classes of ID-bets can vary widely, and the IDBS can accommodate any number of different types of ID-bets, which can be distinguished by differences in terms. For example, one class of ID-bets may all be even-odds bets, while another class may be variable odds. Classes could be distinguished by, say, the maximum stakes allowed.

Thus, the IDBS can include features (sub-modules) for enabling admin authors to define ID-bet classes, to which standard terms and rules apply. In practice, it is likely that admin authors will establish multiple classes of ID-bets.

It is possible that system administrators set all the terms of ID-bets, which is what happens in conventional peer-to-peer betting systems, and other betting systems.

But, there is an important distinction between public authors and admin authors of ID-bet terms. It is hoped that the feature of enabling public authors to set ID-bet terms will be a central and defining reason that the inventive system has utility. A system that only lets admin authors create all the ID-bet terms is drastically more limited. It is especially important to enable public authors to identify SI to be bet about, and to enable public authors to create that central term in ID-bets.

In the disclosure below, the term author will encompass both public and admin authors, and in cases of confusion, context will determine the meaning.

The IDBS can also include means for enabling an author and other users to edit SI identifying information. Thus, more than one user can enter descriptive information to identify SI and, by extension, to identify the IDBO plus its associated ID-bet market.

### Evolution of an IDBO

Creating the terms of an ID-bet is only the first stage in the “journey” of the bet. There are, at least, these potential stages of any ID-bet:
Creation and storage of the ID-bet terms
Making of ID-bet offers
Matching of ID-bet offers
Triggering of the judging of the ID-bet event
Judging and determining the ID-bet outcome (the result)
Transferring money from losing bettors to winning bettors

The system enables each stage and records the stage that the ID-bet is in. Accordingly, the system stores a state of bet indicator in the IDBO to denote the stage of the bet. The system can timestamp each change in state, and store the timestamp(s) in the IDBO as well.

The purpose of ID-bets is to display them to people to describe SI. Therefore, the inventive system can include means for enabling a viewer to find and see the virtually all of the data defining and surrounding an ID-bet, at any stage in the bet process, from creation of the terms, to the making of a ID-bet offers, to the matching of offers, to the settlement of an ID-bet agreement, and including statistics compiled from the ID-bet data. Collectively, the modules described in this Part 1 enable a viewer to see, for instance, the SI that is being evaluated, the ID-bet terms, the amount of money risked on each outcome, who has risked on each outcome, whether the ID-bet is going to be judged, the result if any, and so forth.

### 1.11 Sub-Module for Identifying Subject Information

Since an ID-bet is about SI, an authoring module enables an author to enter SI identifying information to be stored in the IDBO. This module enables an author to request an input form for entering identifying information (part of a longer ID-bet authoring form). When the author enters the SI identifying information, the system stores it.

The IDBS can include and input functionality that enables an author to enter various types of identifying information, including the following.

### 1. Identifying SI by its Location

In a preferred embodiment, the form enables an author to enter the location where the SI can be found. Location is a broad concept, partially defined in the Initial Definitions section. Location of information is how information is found in the real world and online. Therefore, a fundamental part of the utility of the inventive system is to enable all users to find ID-bets using SI location information as an identifier and search term.

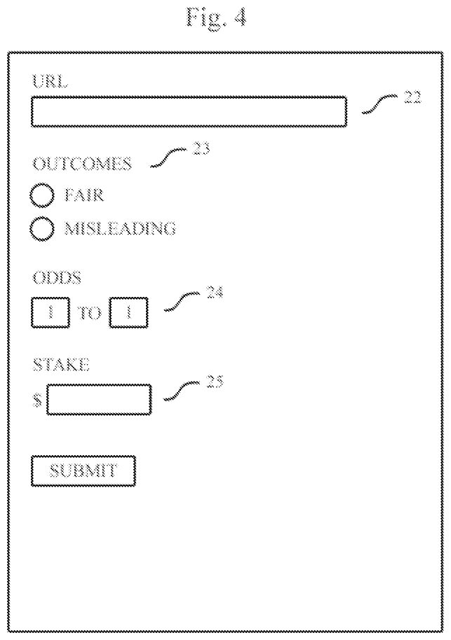

In a preferred embodiment, the system enables the author to enter a URL to identify the SI and where it is located. The system stores the URL in the IDBO. FIG. 4 shows an ID-bet authoring form that enables an author to enter a URL 22 to identify the SI. The rest of the terms are assumed to be held standard. The URL (along with the timestamp that the system adds) sets the unique terms of the ID-bet event, that is, the event is about the description of SI found at that URL.

The advantage of using a URL as an identifier is that URLs are the primary way that people find information on the Internet. A viewer who wants to know about information found at a given URL can query the IDBS, using the URL as a search term, to see if there is an ID-bet about that information. For example, if a user wants to know about the information at webpage.com, she can enter “webpage.com” into the IDBS to see if there are IDBOs that match it. Likewise, Internet-connected computers/services can use URLs as search terms.

The authoring input form can enable other types of location information to be entered and stored. Some of these types are listed in the Initial Definitions under Location of information.

It's important to note that the SI location can be a location in the IDBS database. While SI is originally generated and found outside the IDBS, when an author creates ID-bet terms, the author may enter a copy of the SI into the IDBS, that is, into the IDBO, and the location information can then be the location of the copy in the IDBS. For example, assume the President has made the comment, “The Border Wall will cost $5 billion.” And, assume that this statement can be found on dozens of websites. An author of an ID-bet about the statement could copy the statement and enter it into an ID-bet authoring form to be stored in the IDBO. The authoring form can include fields for entering one of more of the websites as locations, as well, as citations. But, the system can also automatically store the IDBO's location in the IDBS database as the location of the SI. The SI can live, so to speak, in the IDBS, and the IDBO, together with its corresponding ID-bet market (see below), can exist as an information entity without necessarily having a location outside of the IDBS for the SI.

2. Identifying SI that is an Excerpt by Entering its Location Plus a Copy or Description of the Excerpt

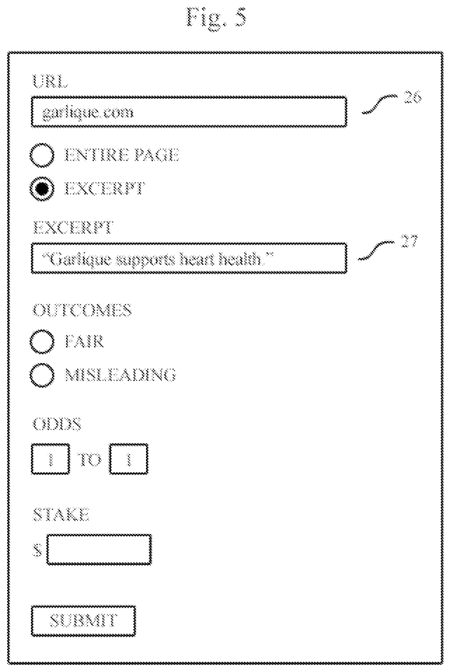

Often the SI will be an excerpt of a larger set of information. Therefore, in another preferred embodiment, the identifying information is a location plus the excerpt. In this case, the input form enables an author to enter a location and a copy of the excerpt. FIG. 5, shows a form that enables an author to enter a location 26, garlique.com, and an excerpt 27, “Garlique supports heart health.”

In another preferred embodiment, instead of a copy of the excerpt, the input form enables the author to enter a description of the excerpt. There many way to describe an excerpt. The description can further specify a location, as with anchor tags that specify the placement of the excerpt in a document. As another example, in the case of SI that is audio or video, a start time and an end time define the excerpt, specifying its location within the initial location. A description can define the excerpt, as in, “second paragraph.” Or, a description can tell what the excerpt is, for example, “warranty reserves in the company's income statement.” These examples in no way limit the kinds of descriptions that the system can accommodate with an author input form.

3. Identifying SI by a Copy that the Author Enters

The author input form can include means for enabling an author to upload a copy of the SI, or a partial copy, and means for storing that copy in the IDBO. The advantage of storing a copy of the SI is that it can enable a viewer to use an excerpt of the SI to search the IDBS to find a matching IDBO. For example, assume the SI is a speech by the President, the full text of which is stored in an IDBO. A viewer could then enter an excerpt from the speech into the IDBS search means to look for a matching IDBO in the IDBS database.

If system enables an author to enter a copy of the SI to be stored in an IDBO, then the system can also include means for automatically creating a link to that copy, which can also be stored in the IDBO. A shareable link enables users to access the SI directly within the IDBS, and can enable the SI to be found by outside services.

The IDBS can also include functionality that heads off the problem of creating duplicate IDBOs about the same SI but each with a different location, e.g., a different URL location. If an author enters a copy of SI, the IDBS can search its database to see if there is any exactly matching SI. If there is exactly matching SI, the system can alert the user and show the user an existing IDBO and existing ID-bet market about the same SI, giving the user the option of not creating a new IDBO about the SI. Note, there can be good reasons to create an additional IDBO for identical SI, especially if the user feels it is important to create an IDBO that includes the location (especially a URL) of the SI.

4. Identifying SI with Descriptive Information

The author input form can include means for enabling an author to enter a variety of information that helps identify the SI, and can make it easier to find via a search.
Name of the speaker
Name of the org the speaker is affiliated with
Time/Date the SI was created
Subject of the SI (which can be described by keywords)
Type of information the SI is, such as audio, video, text, graphics
Title of the SI, as in the title of an article
Where the SI was created
Where the SI appeared

Date or dates that the SI appeared

All such pieces of information can be useful. For example, adding the name of the speaker to an IDBO enables the system to find all the ID-bets where the speaker is the source of SI, and also generate ID-bet statistics about the speaker, that is, statistics summarizing the speaker's betting record, and the ID-bets, if any, about of the speaker's other content.

5. Identifying SI with an Identification Number (Record Locator)

An identification number can be used by a bet author to identify SI. An identification number can also be generated by the system to identify SI. Adding a unique identification number for SI to an IDBO can enable the SI to be found easily (a kind of unique resource identifier), and is especially useful if the SI's location is changed, e.g., its URL.

In some applications, a unique identifier can be considered the SI's more permanent location, wherever the SI happens to be stored.

6. Identifying SI with Question Tags

An IDBO and its corresponding ID-bet market (see below), in combination, is its own information entity. If the SI is copied into the IDBO, or if the IDBO stores a pointer to the SI, then users can search for the IDBO+ID-bet market directly, without searching for the SI in its original location. This aspect of IDBOs+ID-bet market is brought up here in the specification to give context for disclosing a specific type of tag that can be enabled by the IDBS sub-module for entering SI identifying information.

The input form for providing SI identifying information can include a field for entering question tags. A question tag is simply a question. It is tag because the question describes the SI. It may be considered a variation on a keyword description. For example, assume the SI is the statement:
“Three, double-blind studies, run by Mayo Clinic, Columbia University, and the University of Washington have all shown that black cohosh supplements do not reduce hot flashes.”

Assume this SI is stored in the IDBO. Assume, further, there is an associated ID-bet market that describes this statement as ACCURATE (e.g., all bettors in the market have staked money on the outcome ACCURATE).

How would a user find the IDBO and the ID-bet market description?

A user-friendly way is to describe the IDBO and the ID-bet market as an answer to a question, for example, the question, “Does black cohosh reduce hot flashes?” or “Does black cohosh treat the symptoms of menopause?” Adding question tags like these to an IDBO, to enable it and its associated market statistics to be found, can turn an IDBO and its associated market into a free-floating answer entity that can be found directly via the IDBS or any service that searches the IDBS. In this way, the IDBS can become an answer source, with IDBOs+associated market statistics as the answers.

Accordingly, the IDBS sub-module for enabling an author to enter information describing SI can include fields for entering question tags, which the IDBS stores in the IDBO, or associates with the IDBO.

### 7. Identifying and Describing SI by its Sources

It can be useful to identify the sources of SI. The sources of information can vary widely, depending on the information. A scientific paper may have dozens of sources. Sources can include speakers, and also the names and contact information of anyone who witnessed the creation of SI. At bottom, the credibility afforded to information depends on the creators of that information and the witnesses to the creation. Having sources identified in an IDBO, can enable judges of an ID-bet to more easily find those sources. For example, if SI is about the results of an experiment, having the contact information of the scientists who ran the experiment can enable a judge to find the scientists and discuss their results with them.

### 8. Identifying SI by Entering Links to Related SI

If the system enables linking directly to SI, it can also include fields for enabling an author to enter links to related SI. While related SI does not directly identify SI, in combination with other information, it can be used to identify SI. Additionally, and importantly, links to related SI can enable users and outsides services to find that related SI, and related IDBOs, which may be very helpful, just as links on the Internet are helpful for finding information.

### 1.12 Sub-Module for Specifying ID-Bet Outcomes

The ID-bet terms authoring module includes a sub-module for enabling an author to specify and/or create the outcomes of an ID-bet, and enter those outcomes into the system, which stores them as part of the IDBO. Specifying outcomes is like naming the horses in a race to be bet upon.

The outcomes are descriptions of the SI that a judge chooses from when deciding a bet. The outcomes are answers to a question: Which description will a judge pick, given the choices before her? An example of a two-outcome description question is, “Will a judge find that the SI is MISLEADING or FAIR?”

An ID-bet has at least two outcomes. It can have more. An ID-bet event can mean a judge (or a judging process) deciding a particular outcome. Or, ID-bet event can be the act of choosing from among the possible outcomes. Context determines the meaning.

### Enabling an Admin Author to Specify the Outcomes

In one embodiment of the IDBS, the “enter outcomes” sub-module is not presented to public authors because the outcomes are standard. In this case, this sub-module exists for admin authors who set the standard outcomes to apply to a class of ID-bets. Accordingly, the system, upon a request from an admin author:
Presents an interface for entering outcomes for a class of ID-bets,
Inputs those outcomes when the admin enters them into the interface,
Stores the outcomes to apply to a class of ID-bets and associated IDBOs, such that when ID-bet terms and an IDBO in that class are created by an author, the outcomes are part of the terms in the IDBO, and displayed when the IDBO is outputted.

### Enabling a Public Author to Create and Specify the Outcomes

In another embodiment, the sub-module enables public authors to create the outcomes as part of the ID-bet terms. In this embodiment, the system, upon a request from a public author:
Presents an interface for entering outcomes for an ID-bet,
Inputs those outcomes when the user enters them into the interface,
Stores the outcomes in the IDBO of that ID-bet, such that the outcomes are outputted to users who find that IDBO.
   Enabling a Public Author to Select from Among Pre-Set Outcomes

In another embodiment, the sub-module enables public authors to select from pre-set outcome choices. The system, upon a request from a public author:
Presents an interface for selecting outcomes for an ID-bet in a given class of ID-bets, the choices being pre-set, having been associated with the class of ID-bet,
Inputs the outcomes that are selected by the author,
Stores those selected outcomes in the IDBO of that ID-bet, such that the outcomes are outputted by users who find that IDBO.

### Illustrations of Outcomes

Below are examples of useful descriptions of SI that the IDBS can potentially include as pre-set, outcome selections. These descriptions—e.g., Misleading and Not Misleading—can't be defined precisely. Single-word descriptions are given for illustration and brevity; description-outcomes can be longer and more specific.

True/False

Accurate/Inaccurate

Misleading/Not Misleading

Malicious/Safe (e.g., describing computer code)

Acceptable/Not Acceptable (e.g., for content relative to a site's terms of service)

Prohibited/Permitted

Clear/Confusing

Informative/Uninformative

Concise/Wordy

Exact/Vague

Beautiful/Ugly

Matches/Doesn't Match (e.g., relative to a query)

Clickbait/Not Clickbait (e.g., whether a headline fits associated content)

Bettable/Unbettable

Useful/Worthless

Meaningful/Meaningless

Genuine/Not Genuine

Verified/Not Verified

Confirmed/Unconfirmed

Inspected/Not Inspected

Tested/Untested

Proven/Unproven

Sourced/Unsourced

Solicited/Unsolicited

Advertising/Not Advertising

Good deal/Bad deal

### Outcomes as a Scale

Outcomes can be stated as a set of numerical descriptions along a scale. For example: On a scale of 1-N, with 1 being Extremely Misleading and N being Extremely Fair, how would you evaluate the SI? The number of outcomes in this case would be N.

### Descriptions Comparing SI to Other Specified Information

One way to describe SI is to compare it to another set of information using the question: Of two sets of information, which is “better” or “more” or “greater” relative to a descriptive term?

For example, if the descriptive term is “accurate” a comparison could be:
Which is “more accurate,” Information A or Information B?

As another example, if the descriptive term is “overall” a comparison could be:
Which is “better overall,” Information A or Information B?

With a “which is better” comparison question, there can be at least two outcomes: A>B and B>A. Another outcome is “=”. More outcomes are possible, depending on how the comparison is phrased. And, more than one set of information can be compared to the SI. For simplicity, this specification will assume one set of information is being compared to the SI, and that there are two outcomes.

The IDBS sub-module for entering outcomes can include features for enabling this kind of comparison-description of SI.

Accordingly, the sub-module in this embodiment includes another sub-module for entering the second set of information, that is to be compared to the SI. This second sub-module is essentially the same as the sub-module for entering and storing the SI—because it is a module for identifying a set of information. This sub-module enables:
a second, “comparison SI” to be identified,
the identification to be stored in the IDBO,
the identified SI named as the information to be compared with the SI,
the identified SI outputted when the ID-bet terms are output.

To enable a comparison, the IDBS sub-module also includes interface means for enabling an author to enter a comparison question, which the system stores in the IDBO.

The sub-module also includes logic means for creating the outcomes implied by the comparison question. These logic means create at least two outcomes:
SI A>SI B
SI B>SI A

Bettors can then choose between these outcomes.

For example, a comparison ID-bet might compare two movies, where the first, initial SI is Movie A and the second SI is Movie B. The outcomes then would be:
(1) Movie A>Movie B
(2) Movie B>Movie A

Accordingly, the IDBS can include interface and storage means for enabling a public author and/or an admin author to enter the comparison question. If an admin author, the comparison question applies to a class of ID-bets and a class of IDBOs. If a public author, the comparison question applies to a single IDBO.

However, with comparison ID-bets, public authors are the users who enter both sets of SI, the initial SI, and the second set of SI to be compared to the first.

When a comparison IDBO is output, the system can show both sets of SI, or shows a link to each set of SI, so that viewers and bettors can see the sets of information being compared. However, if the user is a machine or an online service, it may not be necessary to output the sets of SI, or links, as the machine user may have no use for them.

A comparison ID-bet is useful because it can enable a viewer to search for SI in the IDBS and see if there is other specified information that the betting market thinks is better. It can be a fundamental improvement to search engines, as when a search result is given, the engine can also show comparison ID-bets that compare that result to other information (see Part 8).

To recap, the IDBS can include a sub-module that executes the following steps:
present user with interface for identifying a first set of SI,
input identifying information for the first set of SI,
present user with interface for identifying a second set of SI,
input the identifying information for the second set of SI,
present user with interface for selecting a comparison question for comparing the SI's,
input the user's selection of comparison question,
store all the user's inputs in the corresponding IDBO,
when a user finds the stored IDBO, output the comparison of the SI's as at least two outcomes that bettors can choose from when risking money on the ID-bet, the two outcomes being generated from the comparison question,
if the user requests it, output the sets of SI or links to the sets of SI being compared.

### 1.13 Sub-Module for Specifying the Judging Procedure

The judging of an ID-bet is a procedure that takes place outside of the IDBS via a human judge because subjective descriptions of information (ID-bet outcomes) can only be judged by humans, at the time of this writing.

Objective descriptions of information, which can be judged by a machine, such as “Does this email contain a virus?,” can be outcomes of ID-bets, and in some cases it may be possible for the judging to be carried out by an automated process.

An ID-bet may never be judged. Judging is triggered when pre-defined criteria are met, and those criteria, like the judging procedure itself, can vary widely.

If the judging is triggered and takes place, the result of the process, the judge's choice of the outcome, is entered and stored in the IDBS. It can be entered by a judge or by a system administrator or by an automated process.

Judging procedures may be standard for classes of ID-bets. Thus, the ID-bet terms creation module can include a sub-module for enabling an admin author to specify the judging procedure, and the class of ID-bet that the judging procedure applies to. The IDBS stores that judging procedure to apply to that class of IDBOs.

The IDBS can also include a sub-module for enabling a public author to specify the judging procedure for an ID-bet.

And, the IDBS can include a sub-module for enabling a public author to choose from pre-set judging options, set by an admin author and that are standard across a class of ID-bets.

Accordingly, as part of the terms authoring form, the IDBS can include options and fields for enabling an author to specify the judge(s) who will determine the outcome, and their costs. If the judging process is custom specified by a public author, the IDBS stores the process as part of the IDBO.

If standard, set by an admin author, the judging process does not have to be stored as part of the IDBO but it can be stored to apply to all ID-bets in the class.

The IDBS can incorporate a host of rules regarding which users pay for the costs of judging an ID-bet. These rules and processes depend on the implementation. Novel processes for paying for judging are not addressed in this specification.

### 1.14 Sub-Module for Specifying the Payoff Rules

Payoff rules are terms that define how money is divided between or among opposing bettors. The most common payoff rules are odds rules. The IDBS can include features for enabling any known odds rules scheme, such as:
Even odds.
Variable odds stated in X-Y terms.
Variable odds stated as decimal odds (see, e.g., betfair.com).
Variable odds stated in the form of securities prices where the price of a security can be between $0 to $1, until the outcome of the bet event is determined, at which time the price goes to $0 or $1.
Pari-mutuel odds.

Odds are not the only kind of payoff rules. Quantity bet rules stipulate a division of money that varies with outcomes that are quantities.

As with other terms or parameters of an ID-bet, the IDBS can include interface means for enabling an admin author to set standard payoff rules for a class of ID-bets. When an admin author sets or selects a payoff rule scheme for a class of ID-bets, the IDBS stores the scheme to be associated with the IDBOs in that class of ID-bets.

And, the IDBS can include features for enabling a public author to choose from among pre-set payoff rule schemes, to be applied to an IDBO. The IDBS stores (or associates) the payoff rules, which are set or selected, with the IDBO.

The IDBS includes logic means (software code) for implementing the payoff rules.

### 1.15 Sub-Module for Specifying the Offer Matching Rules

An ID-bet offer is an offer to exchange money between or among opposing bettors who choose different outcomes of an ID-bet event. As such, an offer can be accepted or matched by one or more “opposing” offers.

In peer-to-peer matching schemes, a bettor's offer can be matched exactly with another bettor's offer, or an offer can be matched with multiple other offers, or partially matched. In pooling schemes, such as pari-mutuel betting, all the offers on a given outcome are collectively matched against all the offers on another outcome or outcomes. The bettors who choose the winning outcome split the money staked by the bettors who have chosen losing outcomes. In securities bets, offers are matched as in the buying and selling of stocks, buying/selling a certain number of shares at a certain price.

The IDBS can include logic means for implementing any known scheme for matching bet offers, and variations on those schemes, which may be novel, and as yet unknown.

While it is possible for the IDBS to enable public authors to create match rules, it is more likely, in practice, that matching rules are held standard, or that a public author can choose from among a pre-set selection of matching rules that apply to a class of ID-bets.

Accordingly, the IDBS can include interface means for enabling an admin author to set matching schemes for classes of ID-bets. The IDBS stores a scheme for each ID-bet class.

And, accordingly, the IDBS can include interface means for enabling a public author to select one matching scheme from among a pre-set selection of schemes, to be applied to the ID-bet terms and stored with the IDBO. When the public author enters a selection, the IDBS stores the matching scheme as part of the IDBO.

### 1.16 Sub-Module for Setting Judge Triggering and Bet Settlement Rules

An ID-bet is decided when a judge decides which description, among the outcome choices, best matches the SI.

Triggering judging refers to setting off a sequence of steps for judging an ID-bet. This triggering takes place in the IDBS when a set of objective criteria are met. For example, when a threshold of money is collected from bettors to pay for the judging.

How judging is invoked can vary widely, but it will, at least, include a message from the IDBS to alert a system administrator or a judging module to begin judge selection.

How judging takes place after the “invoking” step is not the subject of this specification. But, it should be pointed out that the act of judging costs time and money, the act of finding judges takes time and money, and the act of estimating the costs of judging takes time and money. When does the judging take place? What triggers the act of judging? That depends upon implementation and can vary widely.

The IDBS can include means for implementing a variety of rules for triggering judging.

The rules for triggering judging will likely be standard per class of ID-bets.

As with the other ID-bet terms, the IDBS can include means for enabling an admin author to set the triggering rules. The IDBS stores these rules to be associated with the IDBO in the corresponding class. And, the IDBS can include interface means for enabling a public author to choose among a selection of triggering rules to be applied to an IDBO for a single ID-bet.

Upon the decision of an ID-bet outcome, the funds staked by the bettors are distributed, according to the payoff rules. Rules govern this distribution as well, and they can vary.

The rules for collecting money from bettors and transferring money to winning bettors can be called settlement rules. Like the other rules and terms of an ID-bet, they can be set by an admin author or can be selected by a public author, choosing from among selections determined by admin authors. In most applications of the inventive system, it is likely that settlement rules will be standard across a class of ID-bets.

The IDBS will include logic means for implementing triggering rules and settlement rules.

### Specifying Offer Retraction Rules

Rules for retracting money offered in an ID-bet also may need to be specified. So, the inventive method and system can include a process for specifying the retraction rules.

1.17 System Adds Information to the IDBO when Storing it

When an author enters all the information necessary to set the terms of an ID-bet, the system stores the information as the initial IDBO and adds the following information to it:
Identity of the author
Timestamp
Identifier, such as an ID number or primary key, to enable the object to be more easily found in the system database.

As noted above, an IDBO can evolve as the system can add information to it, to reflect actions at each stage of the ID-bet.

Further, when the IDBO is stored, the system can create a link, such as URL permalink (or a well-known equivalent), to the IDBO, enabling it to be accessed directly by users. Users can then share the link, and find and output the ID-bet terms.

### Enabling the IDBO to be Found

The system can also include functionality for indexing the information in the object.

### 1.2 Module for Searching and Outputting IDBO Information

The IDBS includes a module that enables users search for, find, and output IDBOs (output the terms of ID-bets). Users can be humans or computing entities.

All the information stored in an object can be indexed and searched. To restate from above, an IDBO may contain (but is not limited to) the following information:
Name of the ID-bet
Full copy of the SI
Excerpt of the SI
Title of the SI
Descriptions of the SI, e.g., keywords
Question tags (defined above) describing the SI as an answer
Location of the SI, e.g., a URL
Time when the SI was at a location
Identification number, record locator, or symbol for the SI
Speaker of the SI
Outcomes of the ID-bet
Payoff rules
Class of the IDBO
Conditions of the ID-bet
Author of the ID-bet terms
Timestamp of when the IDBO was created

Accordingly, the IDBS can include index means and search means for enabling a user, human or machine, to enter search criteria for matching any of this information.

Search criteria can include graphics, audio and video, which can be matched against SI, if the IDBO contains SI (or if the system can retrieve the SI). For example, a user might enter a picture, or a snippet of audio or video that the IDBS can use to match against the SI or SI identifying information in an IDBO. A copy or partial copy of the SI may be the best way to describe the SI in certain cases. For example, allowing a user to enter a snippet of a speech as search criteria may be the easiest way for the user to describe SI that is a speech.

In practice, users may have apps, on devices outsides the IDBS, that search the IDBS using photo, video, and/or audio as search criteria. A phone (or other device) based app could enable a user to snap a photo of, say, a headline on a piece of mail, and search the IDBS for matching SI. The IDBS, with its search and match means, would then output IDBOs that include matching SI.

To illustrate the principle further, consider an example. Assume a company, CableCo, sends a direct mail letter to a customer and the envelope has the statement “Important Information Inside” printed on it. Or, likewise, assume Coca Cola has printed a label on a bottle of their product, Vitamin Water. A user might want to know if there are any ID-bets about the these pieces of information. Now, a user could try to describe the statement and the label, and enter the description into the IDBS. Alternatively, a user could snap a picture of the envelope or the label and enter that picture into the IDBS to see if there are any IDBOs with matching SI. (Other users may have previously created ID-bet terms about these pieces of information, and bettors may have made corresponding, ID-bet offers.) Entering a photo as search criteria, in these cases, might likely be easier than describing the SI via a text description.

Accordingly, the IDBS can include search functionality executes these steps:
present search interface to user,
user enters a partial copy of SI into the IDBS's search functionality,
IDBS searches for a match in the IDBOs it has stored,
IDBS outputs IDBOs that contain SI that matches the partial copy.

### Creating a Link to the IDBO

As described above, the system can create a link (such as a permalink) directly to the IDBO, which obviates the need for users to enter search criteria into the IDBS. Users who are shown the link can click it to output the linked IDBO.

### Outputting Parts of an IDBO

Along with search functionality, the IDBS will include means for outputting selected IDBO information to users. The set of ID-bet information that an IDBS outputs will depend on the implementation and on the needs of the user. Outputting all the information would, in most cases, be inefficient. The IDBS can include interface means for enabling users to specify the information to be outputted, and will include defaults that direct what is outputted.

It can be very useful to output a copy of the SI so viewers can see what is being bet about. Or, if the SI is not output by default, the system and include an option for enabling a user to request to see the SI, which the system then outputs.

The set of information that is outputted from an IDBO can be minimal depending on the user's needs. A user might only want/need to see, for example, the location of the SI, say a URL, and the outcomes that can be bet upon.

Outputting an IDBO Along with Action Options

Along with outputting the selected ID-bet terms, the system can output interface means that enable the user to ask the system to perform additional actions, especially enabling a user to make an ID-bet offer.

An IDBO is associated in the IDBS database with ID-bet offers, if any exist, that are made using the terms defined in that object. Depending on the implementation, the associated offers, the ID-bet data, that is, may or may not automatically be output along with the object. If associated ID-bet data exists, the system may require a user to request it.

### 1.3 Module for Making an ID-Bet Offer, Creating an Offer-Object, Creating ID-Bet Data, and Creating a Virtual Label for SI

The IDBS includes a module for enabling bettors to make ID-bet offers. This module enables a bettor, after finding the terms of an ID-bet—finding ID-bet terms, to select an option for making an offer according to those terms.

This module provides the bettor and the bettor's Internet-connected device with an offer input form, or the equivalent, that enables the bettor to enter offer information into the IDBS. As with the creation of an IDBO, input can be by text, voice or machine (via an API).

To make a bet offer, a bettor enters her choice of:
1. Outcome
2. Odds (if the ID-bet terms stipulate variable odds) or price
3. Stake

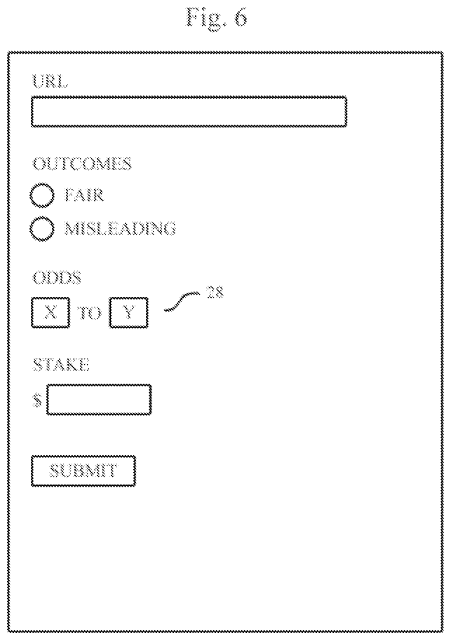

With this information, the bettor offers to risk an amount of money against one or more opposing bettors who choose a different outcome. FIG. 4 shows a web form for entering: an SI identifier (a URL in this case) 22, an outcome 23 (the odds 24 are standard at 1-1), and a stake 25. FIG. 6 shows the same form that also enables the bettor to enter variable odds 28.

Various other pieces of information are necessarily part of an ID-bet offer, such as the bettor's identity, the bettor's account, and the bettor agreement to abide by the terms of the bet. An expiration date for the offer is another example. For brevity, this specification mainly omits these additional pieces of information where they are obvious to those skilled in the art.

### Creating Terms and Entering Offer Information at the Same Time

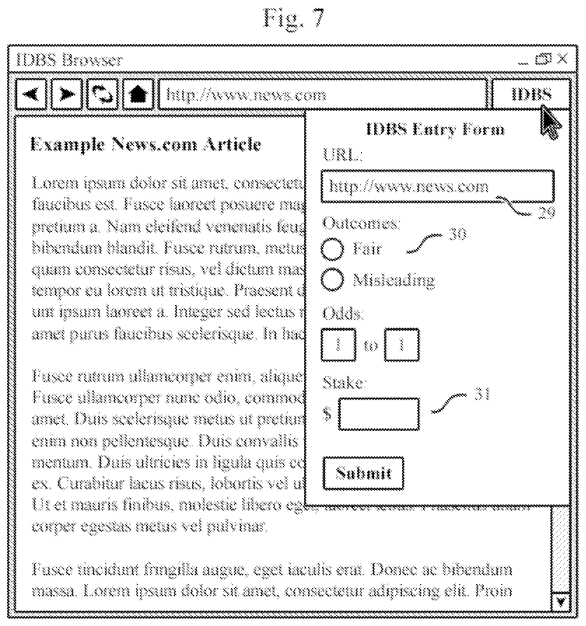

The process of making an ID-bet offer can be combined with the process of creating ID-bet terms. FIG. 7 shows an implementation in which a browser is, in effect, the front end of the IDBS, in which a user can enter offer information and create ID-bet terms and at the same time. The terms are specified in a web form by entering a URL 29, which identifies the SI. It is assumed, in this example case, that the rest of the terms are held standard, only the SI is needed to create the ID-bet event. For the offer information, the user enters an outcome 30 (odds are held standard at 1-1), and a stake 31 to make an ID-bet offer based on those terms.

In another preferred embodiment, a bettor who is speaking in public can use a voice input feature, where the front end of the IDBS is the user's phone, which communicates with the IDBS via an API. A voice input process, in which a phone app acts as the front end, includes temporary storage that enables a user to create an IDBO by enabling the user to:
1. Enter and store a verbal statement that is recorded,
2. Label the statement as the SI of an ID-bet,
3. Enter the remaining bet terms (unless the rest are held standard),
4. Enter a name for the ID-bet (to make it easy for human users to find/retrieve),
5. Submit the IDBO to the IDBS,

In this embodiment, the app executes additional steps, after the user enters the data and “presses submit,”
6. adds the author's name and betting credentials to the IDBO,
7. timestamps the IDBO,
8. adds an identification number to the IDBO,
9. sends the temporarily stored IDBO to the IDBS,

The IDBS then:
10. stores the IDBO and assigns it an identification number and timestamp,
11. sends a confirmation to the app that sent the IDBO.

### Outcome Choice

The system includes means for enabling a bettor to choose an outcome from the outcomes specified in the ID-bet terms. The system stores the outcome chosen.

### Odds (Price) Choice

If an ID-bet's terms stipulate even-odds that are held standard for all offers, the system does not present a choice of odds.

If an ID-bet's terms stipulate variable odds, the system will include means for enabling the bettor to enter her odds, also called the price, that determines the amount of money she will receive in exchange for the amount she has risked. The system stores the odds entered.

The kind of price will depend on the payoff rules in effect, which can vary widely.

The odds (price) can be stated in various ways, well-known in the art. For example, in a security-type bet, the price will be stated in the price of a share of stock. Whatever the form that price takes, the offer input form will include a field or choices that enable a user to enter the price of her offer.

In cases of quantity bets, where the amount that a bettor wins varies with a quantity that the bettor chooses, that quantity is part of an outcome choice. For example, if the ID-bet question is, “On a scale of 1-100, how accurate is the SI?”, the outcomes are the numbers from 1-100. So, quantity bets don't have odds—their “price” is an outcome.

### Stake Choice

The bettor must choose an amount of money to put at stake, to commit and risk, that is. The module will include means for enabling the bettor to enter the stake amount.

### Other Conditions of an Offer

More conditions can be specified in an offer (see U.S. Pat. No. 6,443,841). Thus, the IDBS's offer input form can enable are variety conditions to be added to an offer, including which can be operationalized by corresponding logic means within the system. For brevity, this specification omits a description of means for enabling additional conditions to be added.

Credit and/or Debit Processes

An offer is a commitment to risk money, a stake, on the outcome of a bet. Therefore, the inventive system can include features and processes for transferring a fraction or all of the stake amount from a bettor's account, to be held in escrow, pending the determination of the outcome of the bet. And/or, the system can include a process in which money is not transferred until the outcome of the ID-bet is determined.

In any case, the system can link a user's financial account to a user's bet offer. There are many well-known credit and/or debit accounts and processes that can be included within the system to facilitate the transfer of money and to concretely embody the idea that a bettor has made a financial commitment when making a bet offer.

The utility of the inventive system, in practice, may depend on whether a bettor has to put up some or all of the money staked before a bet is settled. Rules governing how much and when money has to be transferred into an escrow-type account can be called “margin requirement rules.” In practice, they are likely to be held standard across classes of ID-bets. Since credit and debit accounts, and margin requirements are well known, this specification does not delve into them. However, this specification does note that “margin requirements” of ID-bets are likely to be part of the terms of an ID-bet in practice and, if so, the IDBS will include corresponding processes for operationalizing those terms.

### Sub-Module for Retracting an ID-Bet Offer

Offer retraction rules, and corresponding processes, can be highly useful in a system for communicating opinions through bet offers. Accordingly, the system provides a module for inputting a retraction of a bet offer, and storing that retraction in the IDBO.

Sub-Module for Adding Comment Information about the SI to an ID-Bet Offer

As discussed in U.S. Pat. Nos. 5,575,474 and 6,443,841, and patent application Ser. No. 11/017,261, the system can enable a user to enter, along with the bet offer, a text explanation of why he bet the way he did. Thus, the inventive system can include a sub-module for enabling a user to post a comment (including links) with his bet. Further, the system can enable the bettor to create an ID-bet object about the comment, and a make an ID-bet offer about the comment.

### Adding a Contribution to Pay for the Judging

As disclosed in U.S. Pat. No. 6,443,841, the method can include steps for enabling a user to commit to paying some or all of the cost of paying for the judging. The inventive system can enable users to see how much has already been committed. A bettor can make a commitment along with a bet offer or at a different time. In some implementations of the invention, a bettor may be required to contribute.

### System Stores Offer Information, Creates Offer-Object, Creates ID-Bet Data

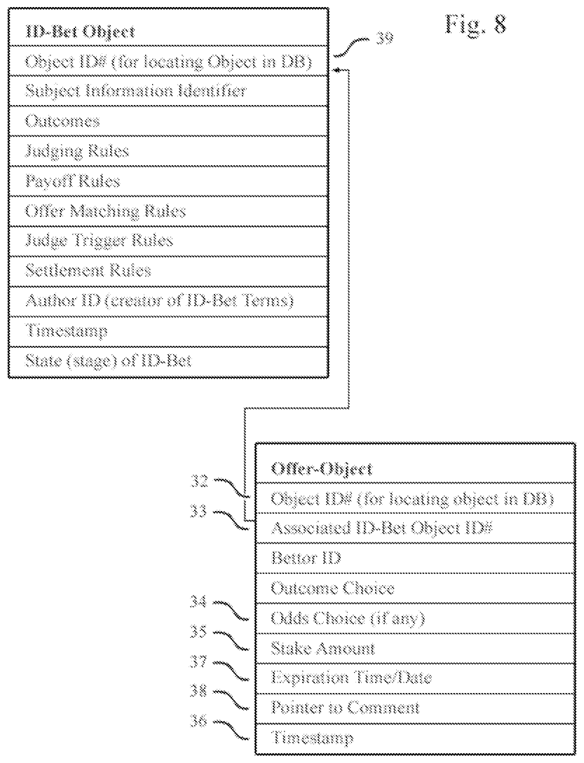

When a bettor enters offer information and submits it, the IDBS stores it and adds identification and association type information. The IDBS stores the combined information as an ensemble in the IDBS database. For convenience, this ensemble will be called an ID-bet offer-object or offer-object. As shown in FIG. 8, initially, an offer-object includes, at least, an offer ID #32 (for finding the offer in the IDBS database), the corresponding IDBOs ID #33 (for associating the offer with its corresponding IDBO), the bettor's ID, an outcome choice, an odds choice (if odds apply) 34, a stake amount 35, and a timestamp 36.

Additional information about a bettor's actions can be added to an offer-object. For example, the offer input form can include a field for entering an expiration time/date 37, which is stored in the offer-object. A bettor may retract her offer, and this retraction is stored in the offer-object. As another example, a user may enter a comment when making an offer. A comment, or a pointer to a comment 38, can be stored in the offer-object.

In other words, a bettor's offer-object will contain all the information that the system records about that bettor's actions with regard to a particular offer.

Additional system-generated information can be added to an offer-object as well. For example, if the offer is matched by the system to another opposing offer, that fact is added to the offer-object. Thus, a bettor's offer-object is the name for the ensemble of information recorded about the bettor's actions and the system's actions regarding a particular offer.

The system can store any number of offer-objects per bettor, each for a different offer.

An offer-object is ID-bet data. It could be considered the “fundamental unit” of ID-bet data. While ID-bet data is a category broader than offer-objects, offer-objects are the “raw material” from which useful statistical descriptions of SI are derived.

### Offer-Object can Store the State of an Offer

An ID-bet offer can be in different states, corresponding to stages of an ID-bet. For example, an offer may be unmatched, matched, sealed (offer retractions not allowed), suspended, judging in-process, settled, paid off, and so forth. It's not possible to be exhaustive about the possible kinds of states as they will depend on the particular rules of implementation.

The system includes steps for registering and storing the state of the offer in the offer-object, or a pointer to the state, such that the state can be retrieved, and can be used for transacting ID-bets, and can be analyzed to generate useful statistics about SI. The state of an offer might be stored globally in the corresponding ID-bet object, or in a separate object for storing offer states. The particular storage scheme is not relevant to this specification—those skilled in the art will see various, essentially equivalent ways to store this information.

Offer-Object is Associated with the Corresponding IDBO and SI

As shown in FIG. 8, a bettor's offer-object is associated 33, 39 in the IDBS database with the corresponding IDBO. This association can be accomplished via well-known database techniques. This association enables the system (and users) to find bet offers associated with a specified IDBO and associated with specified SI.

### IDBS can Create a Link Directly to an Offer-Object

Just as the IDBS can create a link to an IDBO, it can create one to an offer-object. A shareable link makes it easier for viewers to access the offer information. Moreover, the IDBS can include interface means for enabling users to make an offer from a page that displays the offer. Depending on the implementation, it can be useful to respond directly to an offer. A response can be an acceptance of the offer, a counter-offer, or simply another offer regarding the same ID-bet event.

### ID-Bet Offer is a Virtual Label Describing SI

Each offer contains information about SI; it is a description of SI.

For example, assume the homepage of widget.com is SI. A bettor might stake $1,000 at even odds that a judge will find that the content at www.widget.com is MISLEADING.

Thus, each offer-object is a findable, virtual label that describes the SI. The label is not physically placed upon the SI, of course. It is virtual in the sense that it describes the SI, and has been associated with the SI, such that it can be found in the IDBS database and output. It is a label in the sense that an online movie review is a label about a movie.

### ID-Bet Data Further Defined

ID-bet data includes all offer-objects associated with an IDBO.

ID-bet data encompasses more information that may not be stored in offer-objects. Whether an ID-bet is settled, for example, may not be stored in each offer-object. ID-bet data means all the information the system records about user actions and system actions regarding a particular ID-bet.

ID-bet data also encompasses ID-bet market data and ID-bet market statistics, terms that are used interchangeably.

### ID-Bet Market and ID-Bet Market Record

All the offer-objects of all the bettors who have staked money on a particular ID-bet event comprise the ID-bet market for that event. These offer-objects are the raw market data.

The state of each offer is also part of the market data.

The ID-bet market record is all the information the system records about the actions of bettors who make offers according to the terms of an ID-bet, combined with the information the system creates, following the rules of the ID-bet terms. For example, whether an offer is matched to another offer is ID-bet market data.

To emphasize a point made above, there is additional important ID-bet market data that is not captured in offer-objects. In particular, how much money has been contributed to judging an ID-bet event, and whether an ID-bet event is going to be judged, or has been judged, are all important pieces of information about a particular ID-bet event and market. This ID-bet state information is also part of the ID-bet market record.

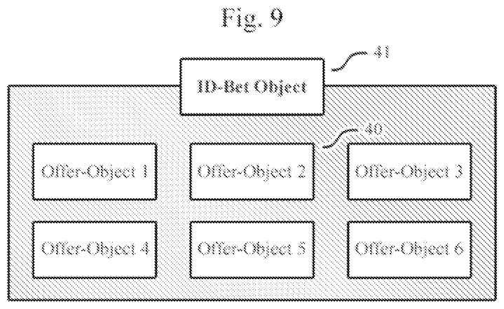

FIG. 9 shows an oversimplified idea of an ID-bet market, in which an ID-bet object 40 is associated with ID-bet offer-objects 41, which comprise the market.

### ID-Bet Market Statistics Are Dynamic, Virtual Labels Describing SI

Statistics that describe SI can be generated from the market record. Such statistics, called ID-bet market statistics, or market statistics, are also virtual labels that describe the SI.

ID-bet offers are a dynamic description of SI because the states of offers can change (e.g., from not matched to matched).

The ID-bet market is dynamic in an additional way. Each additional offer changes the market and the statistics that can be used to describe the SI.

### 1.4 Module for Matching ID-Bet Offers

An offer match creates an agreement between two or more opposing bettors. A match can also be called an acceptance, as in, the offer was accepted. The IDBS will include a module for executing the match rules which, as stated in section 1.15 above, are part of the ID-bet terms. Many different schemes for matching bet offers are known in the art. The inventive system can incorporate any known scheme, including:
Direct, 1-1 matching, in which an offer is fully matched (also called accepted) by an opposing bettor's offer.
Partial matching, in which part of the money in a bettor's offer is matched against an opposing offer. An offer may be partially matched against multiple offers, until the entire offer is matched. Or, an offer may only be partially matched, as when a bettor offers to sell a certain number of shares of security at a certain price, and smaller number of shares are bought or “filled” at that price.
Pari-mutuel matching.

The IDBS logic means can include more than one set of matching rules, each set of rules being applied to a different class of ID-bet. The IDBS can include any practical matching rules and processes and is not limited to currently known rules. The real world IDBS, www.betbacked.com, employs novel, even-odds matching rules.

The IDBS includes logic means for operationalizing (implementing) the match rules.

Further, when a bettor's offer is matched, the system stores a record of the match in the bettor's corresponding offer-object. This record can include the amount of the stake that was matched, and the ID # of the offer(s) that the offer was matched against.

### 1.5 Module for Judging and Settling ID-Bets

The rules for judging and settling an ID-bet are part of the terms. These rules specify what event(s) trigger(s) the selection of a judge, how a judge is selected, how a judge is alerted, how a judge is paid, and how a judge decides the outcome. They further determine how money is divided among bettors. In total, these rules may be complex.

The IDBS includes a module that operationalizes these rules, along with these actions:
a. Paying for the judging of the ID-bet question.
b. Triggering the judging when the conditions for judging have been met.
c. Alerting a judge.
d. Entering the outcome into the IDBS and storing it in the IDBO.
e. Dividing the money according to the outcome selected and the payoff rules.

'841 and patent application '261 describe methods for enabling bettors to pay judging costs. These methods are incorporated by reference. Accordingly, the IDBS includes a module for:
enabling users to commit to paying all or part of the judging costs.
displaying who has contributed to paying for the judging and how much.
triggering the judging upon the satisfaction of trigger conditions.
storing the judge's decision and bet result and displaying it to users.

The IDBS can present a judge with a form for entering an outcome specified in the IDBO, and can provide a form entering an explanation of the decision, as well.

The IDBS also includes a module for dividing the money risked, as specified by the payoff and division rules, established in the creation of the ID-bet terms.

Separately, the IDBS can include a sub-module for enabling a judge to enter profile information about themselves, and to display this profile data to bettors and viewers.

### 1.6 Module for Finding and Outputting ID-Bet Data and ID-Bet Market Statistics

The IDBS includes a module for finding and outputting ID-bet data.

This module includes search means for finding an IDBO and its market record—that is, means for finding the offer-objects for the ID-bet and other ID-bet data.

Raw ID-bet offer information is not as useful as offer information that has been statistically analyzed and organized. Thus, the module includes a market analyzer, also called a market statistics generator, software for generating and outputting ID-bet market statistics.

The analyzer is invoked upon a request from a user who can be a human or a machine.

Accordingly, the module executes following steps:
presents an interface or API to a user for entering a query,
inputs the query,
finds a matching IDBO,
invokes the market analyzer,
analyzer examines the market record,
analyzer generates market statistics,
analyzer sends statistics 42 for output to the user.

Market record statistics describe SI, they are a form of descriptive, dynamic, virtual label. They are the chief product of the system.

Thus, The IDBS will include at least one module for generating market statistics to be output to users: bettors, viewers, Internet services and devices that use the statistics. In practice, an IDBS will likely include many modules for generating and outputting different sets of ID-bet market statistics, suited to different user requirements.

The ID-bet market statistics are somewhat like stock market statistics. A stock price—made up of matched buy and sell offers—provides a short-hand description of a company. Statistics such as market cap and P/E ratio do as well. In a similar, although more direct way, ID-bet market statistics describe SI. Similarly, the IDBS outputs market statistics so they are associated with the SI. That is, when a user finds an IDBO, the IDBS presents market statistics that refer to the SI that is identified in that IDBO.

Market is not a precisely defined term. The possible representations of any complex market are endless. That said, in an IDBS, the concept of a market will be operationalized by modules for generating and outputting representations of individual ID-bet markets.

The market analyzer can output default statistics in response to a general query. Or, the IDBS can include interface means for enabling a user to specify a query for a specific statistic or set of statistics. The IDBS can include API's for enabling computing entities to pull market statistics for identified ID-bets. Market statistics may or may not be shown by default when a user requests an IDBO, depending on the implementation.

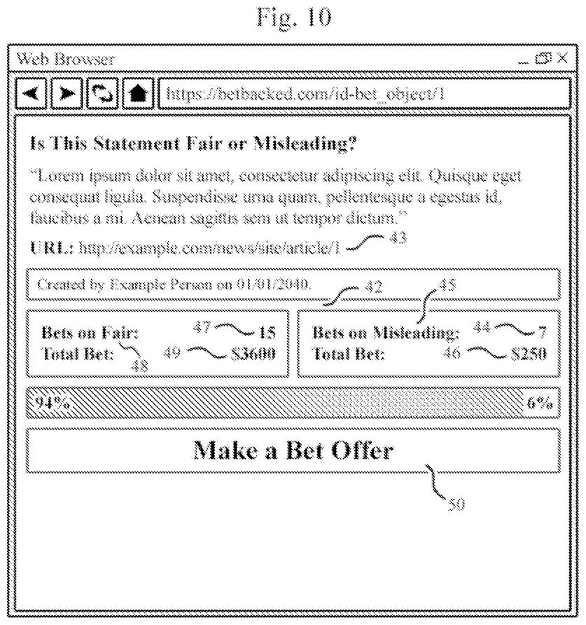

FIG. 10 shows a display of search results based on www.betbacked.com, a real-world IDBS. In this illustrative example, a user has entered a URL 43, which represents SI, to search the IDBS for a match. The IDBS outputs a set of information showing the URL along with market statistics 42 that refer to the SI at that URL. In this example, 7 bettors 44 have staked money on MISLEADING 45, for a total of $250 46, and 15 bettors 47 have staked money on FAIR 48, for a total of $3,600 49. These market statistics describe the SI.

As another example, a market analyzer and display sub-module can show the current odds being offered if the ID-bet terms specify variable odds. Assume that the last ID-bet offer in a market is a bettor offering to stake $100 1-9 on ACCURATE. The IDBS market analyzer and display sub-modules can display that price, or display the prices of all offers currently unmatched and matched in the market, or display the price data in another way. How market analyzer and display modules work depends upon implementation and can vary widely.

Examples of statistics that the IDBS can generate and output in response to a request include, but are not limited to:
Number of bettors staking money on each outcome
Amount of money staked on each outcome
Average amount of money staked on each outcome
Number of unaccepted offers on each outcome
Number of matched offers on each outcome and their prices
Current price of bet offers that were last matched
Current “bid and ask” prices of offers
Amount of money that has been committed for judging
Whether judging has been triggered
Whether the ID-bet has been settled
Result of the ID-bet
The timestamps of IDBO and all the associated offer-objects

Statistics that are displayed can be extensive or can drastically simplify the underlying raw data. As an analogy, movie review sites, such as rottentomatoes.com, aggregate reviews and audience votes (the raw data), and present simple icons and scores (e.g., a tomatometer) to signify whether a move is good or bad. An IDBS market record analyzer and statistical display module can show ID-bet data is a very wide variety of ways, for example, reducing it to a binary indicator, or to a score, or calling out key summarizing values, such as the number of bettors who have staked money on each description in an ID-bet event. The particular ID-bet market statistics that are generated and displayed will vary in practice.

### System Creates Links to ID-Bet Markets and ID-Bet Market Statistics

Just as the IDBS can create a link to an IDBO, and to a singular ID-bet offer-object, it can very usefully create a link to any ID-bet market, and to a set or sets of market statistics that the IDBS generates dynamically.

Link to an ID-bet market means a link to an IDBS generated representation of the ID-bet market for a particular ID-bet event. There are well-known ways to implement such a link.

Such a link, which is shareable, enables users to easily find and share ID-bet market information. In a preferred embodiment, the system includes a sub-module for creating a link, such as a URL permalink, to any ID-bet market.

In a preferred embodiment, the ID-bet market display will also include options for making an ID-bet offer. Thus, a user who sees a link to a market can click it to view market statistics and make a bet offer in the market. Linking to markets and the option to make offers in markets is well known.

FIG. 10 shows a display of search results from www.betbacked.com. In this example, the link 43, takes a user directly a market statistics page 42, where the user can see how much money 46, 49 has been staked on the two outcomes, MISLEADING 45 and FAIR 48 and gives the user the ability to make an ID-bet offer 50.

With the functionality above, an IDBS can be used as a web service. For example, a website with a favorable ID-bet market description may want to display that description. For example, if an ID-bet market deems the content on a website to be accurate—e.g., most of the money staked is on ACCURATE—then the ID-bet market statistics provide a way to certify the accuracy of the information on the website. Therefore, websites will pull ID-bet market statistics about their own content from the IDBS by API.

In addition to showing market statistics, a website can also display a link to the ID-bet market itself, so that the website's users can click the link to view the statistics in more detail, and make ID-bet offers.

### Sub-Module for Creating an SI Quality and Summary Score Using ID-Bet Market Data

Outside services, such an online information filters (see Part 10) and search engine systems (see Part 11) can use ID-bet market statistics to evaluate SI. These services may include software features for taking ID-bet market data and converting it into scores that describe SI. For outside services that do not have such features, it may be useful if the IDBS provides quality scores for SI based on ID-bet market data. Another name for a quality score is an ID-bet market summary score.

The idea of a quality or market summary score is that it summarizes/compresses the information in the ID-bet market data related to specified SI.

Thus, the IDBS can include an SI quality score algorithm as a submodule, which takes the ID-bet market statistics for given SI and converts those statistics into a quality score that describes the SI and summarizes the data in an ID-bet market record in a way that is useful for outside services. A quality score compresses an ID-bet market record similar to the way a person's credit score compresses a person's credit record.

A quality scoring algorithm can incorporate more than just ID-bet market data. It can, for example, incorporate speaker statistics (statistics about the speaker who created the SI being evaluated). In practice, quality scoring algorithms are likely to be complex, can use a wide a variety of ID-bet data including any of the data described in this Part 1 of this specification.

An ID-bet market quality score can be stored in the SI's IDBO and in the SI's ID-bet market record, or in an associated quality score data object. The quality score can be updated with each change in the ID-bet market. Or, the quality score can be generated dynamically upon a request from an outside service, such as a filter, a web crawler, or a search engine.

Accordingly, the IDBS can include software functionality for converting and compressing ID-bet market statistics and related ID-bet data for a specified set of SI into a quality score, which executes the following steps:
receive a request from an outside service for a quality score for specified SI,
find the associated quality score in the SI' associated quality score object,
output the quality score.

Or, which executes the following, similar steps:
receive a request from an outside service for a quality score for specified SI,
analyze the SI ID-bet market record,
invoke the associated quality score algorithm,
generate a quality score,
output the quality score.

### ID-Bet Data Server

It should be noted that the ID-bet data output functions of an IDBS can be accomplished via a kind of proxy server that does not actually transact ID-bets but simply stores dynamically updated copies of the ID-bet data generated by an IDBS. This server can then serve requests that come from the Internet from a variety of users and services. Such a data server itself may be considered a novel, useful invention.

Accordingly, a server system can receive a continuous or near-continuous data feed from an IDBS, e.g., via an API, store that feed, and serve requests for the ID-bet data it obtains.

### 1.7. Module for Combining ID-Bet Markets

One problem that can arise with an IDBS is that the same SI can have multiple IDBO's created for it, each using different locations to identify the SI, especially URL locations. A statement from a Presidential speech may be quoted on dozens of websites. If dozens of users author ID-bet terms about that statement, using it as SI, each citing a different URL where the SI is located, then there can be dozens of ID-bet markets about that identical SI.

One solution to this problem is that the IDBS's search algorithm, if supplied with a portion of the SI as a query to find a matching ID-bet market, may preferentially output the ID-bet markets that have specified characteristics, such as the most bettors, or the most money, or that have ID-bet events that have been settled. The possibilities for an IDBS search algorithm are vast and can't be detailed here.

Another solution is to enable users to flag an IDBO or ID-bet market and send a message to an admin, asking that the ID-bet markets be merged. Thus, the IDBS can include functionality for enabling an admin to locate two IDBO's with the same SI and combine them such that the merged IDBO includes information from both IDBO's, and the offer-objects that comprise the ID-bet markets for both the IDBO's become merged into one larger set, one larger market, that is. The IDBS would then find the combined IDBO and ID-bet market when answering a query about the original SI.

### Part 2

### Modules for Creating and Displaying Descriptions of Bettors and Speakers

The offer-objects for a bettor are a bettor's history. The IDBS can include means for generating statistics from a bettor's offer-objects, that is, from a series of his bet offers.

The IDBS can include calculation means for generating bettor statistics, and interface means for presenting those bettor statistics. These statistics can be used by devices, applications, and services that connect to the IDBS.

Examples of useful bettor statistics are:
Number of winning bets
Number of losing bets
Ratio of winning bets to losing bets
Number of unmatched bet offers
Number of matched bet offers
Net profit or loss from bets

Bettors with better records, such as larger profits or higher winning percentage, may be more trusted than bettors with worse records. And, their ID-bet offers may be given more weight than the ID-bet offers made by bettors with worse records, just as recommendations made by a legendary investor will carry more weight than those of an average investor.

Thus, bettor statistics may be valuable signals in practice, used especially by services that attempt to assign scores to, or summaries of, ID-bet statistics. All manner of scoring and weighting algorithms may be applied to estimate the signaling value of bettor statistics.

The IDBS itself can include functions for adding to or subtracting from the weighting/score assigned to an ID-bet offer, varying with the record of the bettor making the offer.

### Part 3: Modules for Recording the Subject Information of an ID-Bet

### Why Record the Subject Information (SI)?

An ID-bet is about SI, usually identified by a specified location. But, what happens if the information at that location changes? For example, assume an ID-bet in which the SI is the text and graphics at https://www.website.com. And, assume that the IDBO contains this URL as the location of the SI. If the information changes at website.com, is the ID-bet void? It could be, depending on the terms.

Information exists at a location and at a time, and can change. Therefore, it can be useful to record the SI at the time of an ID-bet—to take a “snapshot” of the SI—and have the ID-bet be about that SI, captured at that time.

Modules are disclosed below that the IDBS can include for recording (copying) and storing the SI of an ID-bet at the time that the terms and the corresponding IDBO are created. The copied SI, or a pointer to the copy, can be stored as part of an IDBO, or the copy can be otherwise associated in the IDBS database, with an IDBO, and not necessarily be “contained in” or “part of” that object.

### Three Broad Categories of Information

1. Online information, findable on the Internet (or on intranets), e.g., webpages, videos, downloadable software, and other file types.
2. Electronic messages, e.g., email messages, text messages, direct messages, data feeds, and computer-to-computer transmissions of code.
3. Offline information, “in the real world,” e.g., paper documents, billboards, labels on products, and public speeches.

### What if the Subject Information Can't be Copied?

Any module that directs the IDBS to copy SI will also have steps for dealing with the event that the SI is not found and can't be copied. These steps are omitted the sake of brevity. In practice, the terms of an ID-bet may dictate that the ID-bet is void if a copy of the SI cannot be stored by the IDBS. In this case, the IDBS module(s) for copying SI would include steps for voiding the ID-bet at the creation step and alerting the creator.

### Online Information

This category of information can be divided into two types: (1) full files and (2) excerpts.

A full file will mean all the information, for example a webpage or a document, that can be accessed via a computer, from a location on the Internet, by an Internet user.

An excerpt will mean a specified segment or piece of information within a full file (see also Initial Definitions). Sometimes an excerpt will have its own sub-location, specified in the full file; other times, the location of the segment will have to be:

(a) described by a user (e.g., by providing a start point and an end point in a file) or
(b) copied by a user.

As discussed above, the IDBS interface for enabling a user to create ID-bet terms will include fields for specifying the SI. These fields can include fields for entering a sub-location, or a description, or copy of an excerpt.

### Module for Automatically Recording the SI of an ID-Bet

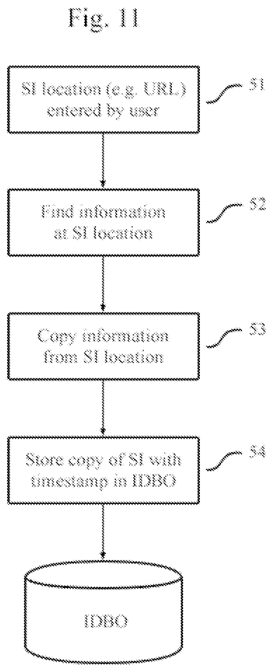

Here we describe a module for copying SI that is a full file and incorporating the resulting record into an IDBO. As shown in FIG. 11, the IDBS can include a module for copying SI that executes these steps:
When the user enters the ID-bet terms (through a terms creation interface), take the SI location (e.g., a URL) entered by the user 51,
find the information at that location 52,
copy that information 53,
store the copy 54 in the IDBO as a copy of the SI at the time that the terms of the ID-bet were created, such that the copy can be retrieved by users,
timestamp the copy and include the timestamp in the IDBO.

A copy can mean a partial copy, that is, enough of a copy such that users can verify and/or agree upon the SI that the ID-bet is about. Depending on the situation, a partial copy may be less costly and equally effective as a full copy.

Storing a copy can mean storing a pointer to a copy stored in a separate database.

Module for Recording SI that is an Excerpt of a Larger File

The module above can also suffice if the SI is an excerpt from a file at a findable location, such as a URL. For example, if the SI is a sentence in a document, making a copy of the full document will also copy the sentence. However, it may be more convenient and less costly to copy just an excerpt that is SI. Thus, the IDBS can include a module for copying just the excerpt. The process will vary depending on how the user who created the ID-bet terms specified the excerpt, particularly its location.

If the user has entered a specific location that the IDBS can find, such as a URL plus an anchor, or pair of anchors, within the document at that URL, then the module described above may suffice.

If the excerpt is a continuous string of text, the IDBS ID-bet terms creation interface (form) can include fields for enabling a creator to specify a start point and an end point of the excerpt in a document.

If the excerpt is a segment of audio or video at a URL, the IDBS can include fields for enabling a creator to specify a start time and an end time within an audio or video file. For example, the creator of ID-bet terms might enter a URL and start time of: 30 and an end time of: 45, which would mean an audio or video excerpt that begins at the 30-second mark and ends at the 45-second mark.

Accordingly, for copying SI that is an excerpt, the IDBS can include a module executes these steps:
When the user enters the ID-bet terms (through a terms creation interface), take the SI location (e.g., a URL), including a start time and end time entered by the user into the bet terms creation form,
find that information at that location, that is, copy the segment of the audio and/or video identified by the beginning time and end time,
copy that information demarcated by those time markers,
store the copy in the IDBO as a copy of the SI at the time the terms of the ID-bet were created, such that the copy can be retrieved by users,
timestamp the copy and include the timestamp in the IDBO.

And, the IDBS can include a similar module that executes these steps:
When the user enters the ID-bet terms (through a terms creation interface), take the SI location (e.g., a URL), including a start point at that location and end point, entered by the user into the bet terms creation form,
find that information at that location, that is, copy the segment of text and/or graphics identified/defined/demarcated by the start point and end point,
copy that information demarcated by those points,
store the copy in the IDBO as a copy of the SI at the time the terms of the ID-bet were created, such that the copy can be retrieved by users,
timestamp the copy and include the timestamp in the IDBO.
   Module for Copying SI that is an Excerpt when a Creator has Entered a Copy

In cases where the creator of ID-bet terms:
enters the location of the larger file, e.g., a URL, and
enters a copy of the excerpt itself,
   the IDBS will store a copy of the excerpt in the IDBO.

While the creator has entered a copy of the excerpt, it may still be useful for the system to make its own copy, because viewers of the IDBO might trust a system copy more and/or may want a verified (double-checked) copy of the excerpt.

Thus, the IDBS can include functionality (means) for matching the creator-entered copy of the excerpt with information at the Internet location specified in the ID-bet terms.

If the IDBS's matching means finds a match at that location, it directs the IDBS to copy the excerpt, including associating the copy with the location of the larger, full file.

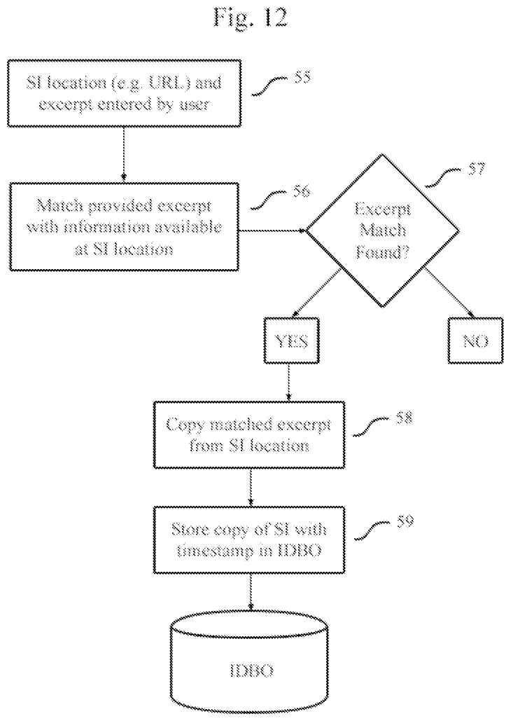

Accordingly, as shown in FIG. 12, the IDBS can include a module that executes these steps:
When the user enters the ID-bet terms (through the terms creation interface), take the SI location (e.g., a URL) 55 and the excerpt copy 56 entered by the user,
at that location, search for information that matches the creator-entered excerpt copy (that was entered via the ID-bet terms interface),
if a match is found, copy the excerpt from that location,
store the system-generated copy in the IDBO as a copy of the SI at the time the terms of the ID-bet were created, such that the copy can be retrieved by users,
in the IDBO, distinguish between the creator-entered copy and the system-generated copy,
timestamp the copy and include the timestamp in the IDBO.

Note, an excerpt may be any kind of information that a creator can copy, including graphics, audio, and video. Thus, the matching functionality can execute these steps:
at the SI location, search for information that matches the audio or video excerpt entered by the creator via the ID-bet terms interface,
if a match is found, copy the excerpt and store it in the IDBO.

### Module for Finding an IDBO by Using a Copy of the Subject Information

As discussed in Part 1, it can be useful for the IDBS to include search means for enabling users to find an IDBO by using a copy or partial copy of the SI that is in the object because that may be the best way to describe the SI in certain cases. For example, allowing a user to enter a snippet of a speech as search criteria may be the easiest way for the user to specify the full speech that she wants to find an ID-bet about. Thus, the IDBS can include modules that execute these steps:
input a partial copy of SI from a user,
search for a match to the partial copy in the IDBOs the IDBS has stored,
output IDBOs that contain matches to the partial SI.
   Creating a Copy of SI that is an Electronic Message that a User has Received

A user might want to create an ID-bet about an electronic message that the user has received. Electronic messages include email messages, text messages, direct messages, and computer-to-computer transmissions, such as transmissions of code, notifications, and data feeds.

Assume that a user has received an electronic message and wants to create an ID-bet about it. The message or part of the message is the SI.

To enable a copy of the SI to be made and stored automatically in an IDBO, the IDBS can include a module that executes these steps:
Receive an electronic message forwarded to an IDBS address for receiving and parsing electronic messages,
Store the message,
Parse the message to identify the party, the forwarder, that has forwarded the message,
Store the identity of the forwarder and associate it with the message,
Parse the message to identify the original sender of the message,
Store the identity of the original sender and associate it with the message,
When the creator of ID-bet terms prompts the IDBS to present its ID-bet terms creation interface, show the interface,
Present the creator with the option to select a forwarded electronic message that has been stored by the system,
Show the creator stored messages in which the forwarder's identity matches the creator's identity,
Allow the creator to select a presented message as the SI for an ID-bet,
When a user enters the terms of an ID-bet and selects a presented message as the SI, the IDBS stores that message as the SI of the ID-bet that the user creates, and stores the copy in the IDBO.

As an alternative to this sequence of steps, the IDBS can enable a user to create ID-bet terms in which a message is the SI, but the message has not yet been received and stored by the IDBS. The IDBS can enable a copy of the message to be stored in the IDBO after the ID-bet terms have been created. The user can identify the message to the IDBS by entering some portion of it, to be matched later. The portion can be the name of the sender, name of the receiver, and/or some excerpt from within the message.

Accordingly, the IDBS can include a module that executes these steps:
Present user with ID-bet terms creation interface,
Store ID-bet terms entered by the user,
Store the sender's name, and/or a portion the information in an electronic message, as information to match with the SI,
Periodically, check a repository of stored electronic messages to see if a message matching that SI has been forwarded to, and stored by, the IDBS,
If a message matching the SI entered by the creator is found, store the message as a copy of the SI in the ID-bet terms, and in the corresponding IDBO.

Now, the SI may be an excerpt in an electronic message. For example, an author may only want to create an ID-bet about the subject line of an email, or a link within the email. To deal with SI that is an excerpt within an electronic message, the IDBS can include ID-bet authoring form that enable a user to enter the excerpt (as discussed above). For example, a creator could enter the subject line into the form. The IDBS can then store that excerpt as a copy of the SI in the IDBO, and also store the larger message that the SI is part of.

Modules for Copying Subject Information that is Offline

Subject information can be offline, “in the real world,” so to speak.

The IDBS cannot find such SI to make a copy because it does not exist in a computer database. For these situations, the IDBS can include modules for enabling an author to copy the SI offline, and enter that copy to be stored as part of ID-bet terms, and as part of a corresponding IDBO.

For example, assume the SI is on paper, say a brochure about an investment opportunity, a label on a bottle of vitamins, or a headline on the envelope of a piece of direct mail. A creator could take a picture of the SI and upload it to the IDBS to be a copy of the SI.

As another example, assume the SI is audio, say a statement made in court, a comment by a politician on a radio show, or a robo-call script delivered by phone. A creator could make a recording of the SI and then upload it to the IDBS to be a copy of the SI.

As another example, assume the SI is video, say a commercial on TV about Wesson Oil, a political ad shown at a rally, or a car ad playing at a tradeshow. A creator could take a video of this SI and upload it to the IDBS to be a copy of the SI.

As another example, assume the SI is a visual display, say a chart on a PowerPoint slide, writing on a booth at a tradeshow, or a billboard. A creator could take a picture of this SI and upload it to the IDBS to be a copy of the SI.

As another example, assume the SI is a live performance, say a political speech, a presentation about a medicine, or an in-person sales pitch. A creator could make an audio or video recording of this SI and upload it to the IDBS to be a copy of the SI.

Accordingly, the IDBS can include a module that executes these steps:
In the ID-bet terms creation interface, present creator with means for uploading a digital copy of the SI,
When the creator uploads (enters) a digital copy of the SI, store the copy as part of the ID-bet terms and in the IDBO, such that the copy is retrievable by other users.

In practice, users may have apps that use photo, video, and/or audio as criteria to search the IDBS database. A device-based app could enable a user to snap a photo of, say, a headline on a piece of mail, and search the IDBS for matching SI. The IDBS, with its search and match means, would then output IDBOs that include that matching SI.

### Automatically Creating a Link to a Copy of SI

If the IDBS automatically copies the SI to be stored in an IDBO, or inputs a copy from an author, then the system can also include means for automatically creating a link to that copy, which can also be stored in the IDBO. A shareable link enables users to access the SI directly within the IDBS, and can enable the SI to be found by outside services.

### Part 6: Modules for Reacting to Changes in Subject Information

### Definition of SI Changes

What does SI changes mean? What does information changes mean? One can't define this concept measurably because it concerns meaning. SI has changed if, at the location specified in an IDBO, the SI is deleted, added to, reduced, or replaced.

What Happens when SI Changes?

If SI changes, the ID-bet data describing it, especially the market statistics describing it, may no longer apply. For example, if the SI found at garlique.com is the statement “Garlique prevents hearts attacks,” and that statement is replaced with “Garlique tastes sweet,” then the ID-bet data about the first statement may not apply to the second, depending on the ID-bet terms. The terms may still apply, provided the change is insignificant with regard to them. Human judgement is usually required to assert whether an ID-bet about SI applies when that SI has changed.

### Sequence of Events for Determining Whether ID-Bet Data Applies to Changed SI

Below is the basic sequence that takes place in order for an IDBS user to assert that ID-bet data does not apply to changed SI. And, below are modules and features the IDBS can include for enabling a user to make the assertion so other users can see it.

### Assume:

1. Outside the IDBS, there exists SI and, stored inside the IDBS exists an associated IDBO (which includes information that identifies the SI) and associated ID-bet data.
2. Outside the IDBS, the SI is changed by a speaker.
3. A user detects the change.
   How does the user detect the change? The user may have created it, found it, or was alerted to it, e.g., by an automated process.
4. The user can assert that the ID-bet terms and data do not apply to the changed SI.
   To enable users to make this assertion so other users can see it, the IDBS requires means for entering and storing the assertion to be associated with the IDBO, such that the assertion can be outputted with the IDBO.
   Thus, the IDBS can include:
      a module for enabling a user to find an IDBO,
      interface means for selecting the object and:
         entering an assertion that the ID-bet terms and data do not apply to the current SI found at the location specified in the IDBO,
         optionally, entering a reason for the assertion,
         optionally, entering a description of the difference between the SIs,
         optionally, entering a link to a different IDBO that is about the changed SI,
      means for outputting this assertion, and associated entries, when any user outputs the IDBO and/or associated ID-bet data.
   Thus, if a user enters an assertion that the ID-bet data does not apply to the current SI, the IDBS stores the assertion in the IDBO and/or with the ID-bet data, such that the assertion can be retrieved when the ID-bet data is retrieved.
   The IDBS can also include a module for, and execute the additional step of:
      sending an alert to the bettors in the ID-bet market record, informing the bettors of the assertion.
   This alerting feature may be critical in practice to keep ID-bet data more current than it otherwise would be. An alerting function would allow bettors who have made ID-bet offers about the SI to learn about the change, and to then make new bet offers and/or make assertions about whether their bet offers apply to the changed SI.

An assertion can include identifying a new IDBO about the changed SI. That is, if a user has created a separate IDBO about the changed SI, that user, or other users, can reference this new object when asserting that the first bet object does not apply to the changed SI. The identification can be a link, enabling any user to find the new IDBO from the “old” IDBO where the assertion has been stored. Hence, as described above, an assertion can include a link to the different IDBO about the changed SI.

Module for Automatically Recording Changed SI when a User Makes an Assertion

If a user asserts that SI has changed at a location, it can be useful for the IDBS to store and output proof of the change, to validate the assertion, and show other users what the change is.

Accordingly, the IDBS can include a module that executes these steps:
when a user enters an assertion, associated with an IDBO, that the ID-bet terms in the object do not apply to the changed SI,
find the information at the location specified in the ID-bet terms,
copy that information,
store the copy in the IDBO as a copy of the changed SI at the time that the assertion is entered, such that the copy can be retrieved by users,
timestamp the copy and include the timestamp in the IDBO.

### Module for Detecting Changes in SI and for Alerting Bettors

If the IDBS stores a copy of SI, it is also possible for it to include functionality for periodically scanning the location of the SI to detect changes in that SI.

Accordingly, the IDBS can include a module for executing these steps:
Periodically, find an IDBO stored in the IDBS database,
Find the SI at the location specified in the object,
Compare the SI found at the location to the most recent copy of the SI stored in, or associated with, the object,
If the comparison yields a difference, set flag in the object that the SI as changed, such that the flag can be retrieved when the IDBO is retrieved,
Alert the bettors in the ID-bet market that the SI has changed.

### Multiple IDBOs for a Single Location Leads to an Open Question

An SI location can have multiple IDBOs associated with it, created about different SI, corresponding to different times. Within practical limits, there can be any number of IDBOs created about information at a location.

If an IDBS outputs more than one object associated with a location, that can confuse users. Which bet object should a user pay attention to? It's an unsolved question.

Conventionally, the current information at a location is the information that is found and consumed by users—when one goes to NYTimes.com, one sees the current homepage of the NYTimes.com, not the homepage from 6 days before. But, IDBOs and ID-bet data are meta-objects that are associated with a location and exist apart from it. It's not clear which bet objects and data should be shown for a location, especially if there are incentives for bettors to deceive by creating new IDBOs and ID-bet offers about SI at a location.

For users of an IDBS for ID-bets, it is important to minimize changes in SI that are motivated by an intent to deceive. Below are five cases.

### Five Illustrative Cases Showing Modules for Deterring User Deceptions

We examine five cases in order to disclose additional modules that the IDBS can include for enabling IDBS users to (a) evaluate changing SI, (b) curb deception by speakers and bettors, and (c) reduce the labor that can be incurred monitoring SI that is described by ID-bet data.

Recall that the purpose of ID-bet data is to describe SI, the data is a kind of virtual label that is “attached” to the SI. In the hypothetical cases below, the ID-bet data descriptions are oversimplified as “good” or “bad.” The labels “good” and “bad” are binary abstractions representing a multitude of possible descriptions. They are oversimplified to make the analysis manageable and to disclose novel features/modules that the IDBS can include.

Case 1: SI is “bad” according to the ID-bet data, and then the SI, or SI location, is deleted.

Assume there is an IDBO about SI located at envita.com/treatment. Assume, further, there is a market with 85 bettors who have made offers and have all chosen the outcome “bad,” a unanimous market vote that the SI at envita.com/treatment is bad.

And, also assume that the owner of envita.com, the speaker who has authored the SI, is unhappy about this ID-bet data, so he deletes the SI or the location of the SI.

This speaker can then use the modules described above to assert that the ID-bet terms and data no longer apply, and he can assert that the SI is deleted.

In this hypothetical case, the IDBS system has “worked,” labelling information with ID-bet data has resulted in bad information being recognized and then deleted.

Case 2: SI is “good” according to ID-bet data, and the SI is changed to bad, but no new IDBO is created for the new SI.

As an example, assume an article on the effects of high-dose vitamin C is accurate and that it is the SI of an IDBO, and there exists ID-bet data that describes the article as “good.”

Assume the article is then revised to be misleading, but the IDBO and ID-bet data are not changed. In this case, the ID-bet data, showing “good,” will be misleading.

To prevent the lack of updating of an IDBO and the associated ID-bet data, when SI changes, it is necessary for a user or users to detect the change, and create a new IDBO for the changed SI, allowing new offers to be made about the new SI.

A user or users would have to monitor or stumble on the SI to detect the change. Or, users could be alerted to the change by an automated process, as disclosed above.

One solution, which may be outside of an IDBS, is a meta-rule that speakers are required to create new IDBOs when they change SI.

Case 3: SI is “bad” according to ID-bet data, and the SI does not change, but a new IDBO is created for it, with no bet offers made.

Taking the Case 1 above, assume differently that the speaker is unhappy about this ID-bet data, but does not change the SI. Instead, he creates a new IDBO about the SI, using the same SI location.

This new IDBO will not have any associated bet offers, so the ID-bet data will be nothing. In this way, if viewers see this new object with no associated bet offers, and don't see the previously created bet object, the viewers will be fooled. The speaker, who has created the new IDBO, will have wiped the slate clean, so to speak.

To prevent this deception, the IDBS can include a module for checking whether SI has changed and can execute the following steps, when an IDBO is being created:
Find the SI at the location specified in the IDBO,
Check if there is another object with the same SI location,
If so, compare the SI at that location to the most recent copy of the SI associated with the IDBO,
If the comparison shows the copy and the SI found at the location are duplicates, block the new IDBO from being created.

If this module does not exist, or if the SI location is not accessible to the IDBS, then other features are necessary to deter or reveal this deception.

The key defense against this deception is an IDBS search/output algorithm (see below) that enables users to see less recently created, yet more relevant IDBOs and ID-bet data about the SI at a location.

Another defense feature is described below in the discussion of Case 4.

Case 4: SI is “bad” according to ID-bet data, and the SI does not change, but a new IDBO is created for it, and bet offers are made on the outcome “good” so that the new ID-bet data describes the SI as “good.”

Case 4 is the same as Case 3 except that, in addition, the speaker, the creator of the SI, or another user, also makes an ID-bet offer or offers using the new bet object. In these offers, the user(s) risk money on the outcome “good” and so the ID-bet data describes the SI as “good,” which is opposite the previous bet data.

A defense against this deception is that bettors can make new bet offers on “bad.” But, that is time consuming and there is a lag. Users would not want to make repeat bet offers about the same SI or essentially the same SI.

The IDBS can include a module and steps for enabling users to challenge and, ultimately, penalize other users who create IDBOs and/or ID-bet offers about SI that has not changed, or about SI that has changed in such a way that it is trivial with respect to the terms of an existing IDBO.

If the IDBS enables users to challenge each other, it will include adjudication and resolution processes. Accordingly, the IDBS can include a module for:
Finding an IDBO,
Presenting interface means for enabling a user to make an assertion that the object is frivolous (or the equivalent), i.e., that it violates the terms of service of the IDBS,
Entering and storing an assertion that an IDBO violates the system's terms of service, such that the assertion can be retrieved when the object is outputted,
Identifying and storing the identity of the user making the assertion,
Alerting the author of the IDBO that is has been flagged by another user as being in violation of the system's terms of service,
Alerting a user who is a system judge to determine whether the assertion is correct, according to the meta-terms of service of the system,
Presenting an interface for enabling the judge to enter a decision,
Storing the judge's decision,
Penalizing the author if the judge's decision finds the author's change is frivolous.

Case 5: SI is “bad” according to ID-bet data, and the SI at that location changes in a way that is trivial with respect to the ID-bet terms that were created for the original SI. A user creates a new IDBO for the changed SI and the user(s) make ID-bet offer(s) on “good,” which means the new ID-bet data describes the new SI as “good,” the opposite of the ID-bet data about the original SI.

This case is essentially the same as Case 4. A user who wants to create a new IDBO for the purpose of deceiving might want to change the SI in a trivial way to justify the new bet object, and also to evade an IDBS module that blocks ID-bets about duplicate SI.

As described above, the IDBS can include a module for enabling users to flag trivial changes in SI, and to penalize other users who create new IDBOs, and/or make new ID-bet offers, about trivially changed SI.

### Module for Challenging and Validating Assertions

The IDBS can include a variety of modules for enabling users to challenge each other's assertions, including modules whereby users lose money if their assertions and/or their challenges to assertions, are found wrong, and win money if they are found correct. The IDBS can include processes for charging fees for having challenges adjudicated.

### Algorithmic Solutions

Search and output algorithms are essential to an IDBS. When user enters an SI location to find IDBOs that match that location, there may be multiple objects that match that query. How to rank the output those objects is a fundamental problem. Suffice to say that a variety of factors can be incorporated into the search algorithm, including but not limited to: time/date when an object was created, the amount of money risked on outcomes for a given object, the number of bettors in the market, the amount bet per bettor, the number of bet objects created for a location and their dates of creation, the outcomes that are favored by the bettors (for example, the search/output algorithm could favor outputting objects and market statistics that describe SI as “bad” over those that describe SI as “good”).

### Part 5

### Module for Financial Safety

Betting can ruin lives. Life savings built up over decades can disappear in a day's worth of losing bets, or dribble away over years of delusional gambles. Expertise is a poor defense—anyone who can risk her whole bankroll can be wiped out, fast or slow.

Can bets on the IDBS be made safe for bettors? Yes. The system can include software-enforced rules that limit a user's financial risk. Such rules require that a bettor apply for a betting limit, similar to a credit limit. If a bettor loses his limit, a smaller limit can be approved, which would get progressively smaller each time the better loses the limit, until the bettor can no longer bet.

Accordingly, the IDBS can include a module for assigning a betting amount limit to a user, monitoring whether the user has lost that limit, and restricting the amount the user can stake in a bet if the user has lost the assigned limit.

Further, the system can include algorithms that take into account a user's net worth and can restrict the amount of money a user can bet to a specified percentage of the user's net worth.

### Preface to Parts 6-11

The inventions disclosed in Parts 6-9 may require divisional applications, as they are different from the IDBS. However, they work with the IDBS, and in combination form a larger system, which is why they are disclosed in this specification.

### Part 6

Browser with ID-Betting Functionality that Interacts with System

Here disclosed is a web browser with functionality that enables a user to conveniently author the terms of an ID-bet about SI on a webpage, and to conveniently make an ID-bet offer about that SI, according to the terms of the ID-bet.

As a concrete illustration, assume a webpage at the URL www.news.com, and assume a user sees the content with his browser and believes the whole page is misleading. Assume, further, that the user wants to author an ID-bet with outcomes MISLEADING and NOT MISLEADING, and wants to make an ID-bet offer on MISLEADING. A browser with ID-betting functionality, described below, enables the user to do these things, thereby enabling the user to describe the content.

This functionality enables a user to easily and automatically identify SI by a URL, and then easily create ID-bet terms, that is, create an IDBO, and send that object to the IDBS.

Likewise, this functionality enables a user to easily make an ID-bet offer, that is, create an offer-object associated with the IDBO, and send the offer-object to the IDBS.

The browser can also store a user's credentials (account information) for making ID-bet offers through the IDBS. Alternatively, the user's ID can be enough to submit an offer to the IDBS, if the user has an account with the IDBS.

Accordingly, in a preferred embodiment, the browser's user interface includes an option for creating ID-bet terms 29 (by entering a URL) and an option for making an ID-bet offer 30, 31. The browser includes software functionality that executes the following steps, when a user selects the “Create ID-bet Terms” option:
1. Stores, in temporary memory, the URL of the current page in the current browser window, the URL acting as the SI identifier, in a set of ID-bet terms,
2. Presents an input form to the user for setting the remaining ID-bet terms,
3. Registers and stores, in temporary memory, the user's selections of the remaining terms necessary to be set, thereby temporarily storing an ID-bet object (IDBO),
4. Presents the user with the option of submitting the form information and URL, that is, submitting the stored IDBO to the IDBS,
5. Upon the user selecting the “Submit ID-bet Terms” option,
   a. Adds the user's ID to the IDBO to denote the user is the author,
   b. Adds an identification number to the IDBO,
   c. Adds a timestamp to the IDBO,
   d. Sends the IDBO to the IDBS,
   e. Receives a confirmation from the IDBS that the IDBO is stored,
   f. Presents the confirmation to the user.

The browser further:
1. Presents user with the option for making an ID-bet offer, about the SI identified by the URL of the current page, and according to the ID-bet terms set by the user,
2. Upon the user selecting the “Make Bet Offer” option, presents an offer input form,
3. Enters the user's bet offer information: outcome, odds (if any), and stake and, optionally, a comment about the rationale for the offer, and stores this information in temporary memory as an offer-object,
4. Presents the user with the option to submit the offer information (the offer-object) to the IDBS,
5. Upon the user selecting the “Submit Terms and Offer” option:
   a. Adds the user's ID and betting credentials to the offer-object as the bettor ID,
   b. Adds an identification number to the offer-object,
   c. Adds association information (such as a database key) to the offer-object, relating it to the IDBO,
   d. Adds a timestamp to the ID-bet object and the offer-object
6. Sends the IDBO and the offer-object to the IDBS,
   a. Receives a confirmation from the IDBS that offer-object is stored,
   b. Presents the confirmation to the user.

As shown in a preferred embodiment, the browser's ID-betting functionality combines the process of creating the ID-bet and the process of making an offer about the SI of that ID-bet. In practice, both operations can be done in the same process, or can be split.

In practice, if browsers with ID-betting functionality become popular, most ID-bet terms will likely be held standard so that browsers enable common bets forms, which encourage more use. The more terms that are held standard, the easier for the user.

With standardization, the browser's betting functionality can enable a user to create ID-terms and make an offer with little effort. For example, assume that there is only one standard ID-bet type available, with one set of rules, in which a bettor can choose between the outcomes MISLEADING and NOT MISLEADING. Now, assume a user arrives at www.news.com and wants to bet that the content on that webpage is misleading. He would choose the “Make a ID-Bet Offer” option. The browser would capture the URL for that page as the SI identifier, setting the ID-bet terms. And, the browser would also present an offer form for entering an outcome, MISLEADING or NOT MISLEADING, and for entering the stake to be risked. The rest of the terms and offer information can be standard, with no additional input needed from the user.

Where terms are standard, the IDBO can include an ID-bet class signifier denoting what standard terms and rules apply to the ID-bet.

Thus, in a preferred embodiment, the browser's user interface includes an option for “Making an ID-bet Offer” that enables the user to create bet terms and make a bet offer at the same time. When the user selects this option, the browser executes these steps:
Store the URL of the current page in temporary memory to be part of an IDBO and an associated offer-object,
Present outcome selections to the user,
Upon the user selecting an outcome, store the outcome in temporary memory as part of the offer-object,
Present a form for entering a stake amount to be risked in the bet offer,
Upon the user entering a stake amount, store the amount in temporary memory as part of the offer-object.
Present the user with the option to submit this stored IDBO and associated offer-object to the IDBS,
Upon the user selecting “Submit,”
   add the user's ID to the IDBO, as the author,
   add the user's ID and betting credentials to the offer-object, as the bettor,
   add an identification number to the IDBO,
   add an identification number to the offer-object,
   add an association (e.g., a database key) relating the IDBO and offer-object,
   add a timestamp to both the IDBO and the associated offer object,
   add the class of ID-bet to the IDBO,
   send the IDBO to the IDBS,
   receive confirmation from the IDBS that the IDBO and offer-object are stored,
   present the confirmation to the user.

The browser's ID-betting functionality can include logic and interface options that enable a user to make and submit any kind of bet offer that the IDBS enables. The browser can enable an ID-bet and offer with a comparison outcome, in which two sets of SI are compared (see section 1.12). In this case, the browser's ID-betting functionality enables the user to enter a second set of SI identifying information, for a second set of SI that is to be compared to the first. And the browser enables the user to choose an outcome that one set of SI will be better than another according to some specified quality. With this capability, the browser enables a user to enter information into the IDBS, which identifies information that is not on the website but is potentially better than the information on the website.

For example, assume a website garlique.com displays the statement, “Garlique supports heart health.” A user, using an ID-betting browser, could highlight the statement as the first set of SI, and create a comparison-outcome ID-bet. The user could further enter a second set of SI (or SI identifying information) into the IDBO. Assume the second set of SI is the statement, “Research has shown that Garlique provides no benefit to the heart. Sources: www.medline.com/garlique.” Now, an ID-bet has been set up that pits two sets of SI. The user can then make an ID-bet offer that the second statement is more accurate than the first. Viewers of the website can then enter the URL, garlique.com, into the IDBS and find the ID-bet about the two statements, and can see that one bettor, at least, has made on an ID-bet offer by staking money on the second statement being MORE ACCURATE. In this way, an ID-betting browser can improve the quality of information on the Internet.

Enabling an ID-Bet Offer about an Excerpt

Rather than make an ID-bet offer about all the content on a webpage, a user might want to identify and bet about an excerpt. Thus, a browser with ID-betting functionality will enable a bettor to select an excerpt on a page, create an ID-bet about the excerpt, and make an ID-bet offer about the excerpt.

The browser's user interface will include an option for enabling the user to choose “Whole Page” or “Excerpt” as the SI. The browser enables a user who has selected “Excerpt” to select (“highlight”) the excerpt by any way that is well known in the art. The browser stores a copy of the selected part of webpage, and stores a copy of that selection temporarily to be used as part of an IDBO.

Regarding the sequence of events, the browser's ID-betting functionality can enable a user to first select an excerpt and then choose a user interface option of “Make an ID-bet About the Excerpt.” Whether the user selects the excerpt first and then chooses a “Make a Bet Offer” option, or vice versa, the browser's software enables the user to create an ID-bet and make an ID-bet offer about the excerpt by nearly same process as described above in which a whole page is the SI. The difference in the process is that the excerpt is the SI.

Accordingly, when the user selects a portion of a webpage and then chooses the “Make an ID-bet About This Excerpt” option, the browser executes these steps:
Store the URL of the current page in temporary memory to be part of an IDBO and an associated offer-object,
Store a copy of the selected excerpt in temporary memory to be part of the IDBO, as the SI of the ID-bet, and the SI of an associated ID-bet offer-object,
Associate the URL with the copy of the excerpt such that, together, these pieces of information identify the SI.

The rest of the steps are the same as above, the difference being that the copy of the excerpt has been added as the SI identifying information.

Whatever the particular procedure that the browser employs for enabling a user to submit an IDBO and an ID-bet offer to the IDBS, the key steps for enabling an excerpt to be SI, are: (1) the browser enabling the user to select the excerpt, (2) the browser storing and a copy, along with the URL of the page that the excerpt is on, (3) associating these pieces of information to identify the excerpt as the SI of the user-created ID-bet, and the SI of the user's ID-bet offer.

For cases where the excerpt can't be conveniently copied, the browser's ID-betting functionality will also include input forms and logic steps for enabling the user to describe the excerpt, and store that description in the IDBO, to be submitted to the IDBS. As explained in section 1.11, there are many ways an excerpt can be described. For example, the description can state the position of the excerpt on a webpage. Or, the description can be discursive, as in, “the bar graph describing corn shipments.” In particular, if the excerpt is a segment of SI is video or audio, the browser can enable the user to enter the start and end time of the segment.

It is possible and convenient for the browser's ID-betting functionality to include means for enabling the user to set the same ID-bet terms for all the ID-bet offers the user makes. That is, the functionality can enable the user to set default ID-bet terms. In this case, a user would not have to select a Create ID-bet Terms option, but would only need to select a Make ID-bet Offer option regarding any webpage or excerpt that is selected to be the SI of an ID-bet offer.

Viewing Existing ID-Bets about a Webpage

What if an ID-bet already exists about information on a webpage?

It would be useful and convenient for a browser to fetch and display the ID-bet statistics for any and all SI at a URL that the browser visits. Otherwise, the user has to use the URL separately search the IDBS to find the ID-bet statistics and match them up to the content at the URL. Thus, a novel browser with betting functionality can also include ID-bet viewing functionality that interacts with the IDBS.

There are two broad cases that a browser can encounter.

Case 1: The ID-bet is visible on the webpage because the website has pulled ID-bet market statistics from the IDBS, and displayed them on the website. The display may include a link back to the ID-bet market with the option to make an ID-bet offer. Or, the displayed data may include functionality for making an offer directly from the website.

In this case, if the user trusts the website to be pulling genuine information, then the ID-bet information displayed on the website suffices. If the user does not trust the information on the website, the browser can include software that double-checks the information displayed on the website and notifies the user if the information that the browser pulls differs from the information that the website pulls.

Accordingly, a browser with ID-bet viewing functionality an include logic means that executes the following steps:
take URL of the current page in the current browser window,
using the URL as a search term, search the IDBS for ID-bets about SI on the webpage corresponding to the URL,
if any ID-bets and corresponding market statistics are found, check the statistics against the statistics displayed by the website at the URL,
   if the statistics match, notify the user that the statistics match,
   if the statistics don't match:
      notify the user that the statistics don't match,
      show the user the statistics that were found at the IDBS,
      show the difference in the statistics shown by the website and IDBS.

Case 2: The website does not display any ID-bet information, but in the IDBS there are one or more ID-bets about the information on that webpage. This case will occur often if the ID-bet market statistics describe a website's information unfavorably. For this case, the browser can include ID-bet viewing functionality for displaying ID-bet market statistics from any ID-bet market that describes information on the webpage. The browser's viewing functionality can present these statistics to the viewer along with the SI, on the webpage being viewed. In other words, market statistics about SI on a webpage can be shown to viewers of that SI.

This ID-bet viewing functionality executes the following steps:
take URL of the current page in the current browser window,
using the URL as a search term, search the IDBS for ID-bets about SI on the webpage corresponding to the URL,
if any ID-bets and corresponding market statistics are found,
display the market statistics about SI on the webpage identified by the URL,
for each ID-bet market found, pull a link to the market from the IDBS, and display the link on the browser's current page, enabling the user to visit the market page found at the IDBS.

An alternative is to not display market statistics but to display an option for seeing the statistics. When the option is chosen, the browser would reveal the statistics. Another alternative is to abbreviate the statistics, such as an up or down arrow, and a link to the detailed market statistics.

In a preferred embodiment, the browser's ID-bet viewing functionality shows market statistics close to the corresponding SI on a webpage. For example, assume the statement, “Garlique supports heart health” is on garlique.com. The viewing functionality can add a link next to the statement that leads to the ID-bet market statistics for that statement. And, the viewing functionality can include abbreviations of the statistics so viewers can quickly see what the betting market thinks of the statement. An abbreviated statistic shown alongside the statement might be the amount of money on MISLEADING versus the amount of money on NOT MISLEADING.

Alternatively, market statistics can be shown in a separate pane or in innumerable other ways. In any embodiment, the viewing functionality will display the market statistics, or a link to the market statistics, near enough to the SI so that the connection is clear, and such that a viewer seeing the SI can easily view the market statistics, too.

If there is more than one ID-bet market about information on a webpage, how to rank the different market statistics in the browser's display? The browser will include a ranking algorithm for sorting and displaying the ID-bet markets that correspond to a URL. There can be a profusion of ID-bets about SI on a single webpage. If a webpage has 30 assertions of fact, there may be an ID-bet market for each assertion. If the assertions have changed, there may be “legacy” ID-bet markets as well. Thus, a part of a browser's ID-bet viewing functionality is an algorithm for ranking the market statistics, found in an IDBS, that are then displayed by the browser along with the content at the URL.

The browser's viewing functionality executes the following steps:
take URL of the current page in the current browser window,
using the URL as a search term, search the IDBS for ID-bets about SI on the webpage corresponding to the URL,
if more than one set of ID-bet market statistics is found, apply the list of ID-bet market statistics to an ID-bet sorting and ranking algorithm,
display the market statistics in the order dictated by the algorithm.

### Part 7

Social Media System and Content Management System with ID-Betting Functionality

A social media system, also called a social media messaging system, is an online communications system where users create messages, also called content, that they post for each other on the Internet. The messages may be posted publicly or privately. A content management system is equivalent for the purpose of this disclosure, as a content management system enables users to post content to the Internet. The term social media system will encompass social messaging systems and content management systems.

Here disclosed is an improvement in social media systems. A social media system's features for creating content are improved by adding ID-betting functionality. With this functionality, a user can conveniently (1) author the terms of an ID-bet about content (SI) that she creates and posts, (2) make an ID-bet offer about that content, (3) submit those ID-bet terms and that ID-bet offer to an IDBS, and (4) post the ID-bet terms and ID-bet offer alongside her content.

This functionality can also enable a user to author/post ID-bet terms, and make/post an ID-bet offer about another user's posted content.

An IDBS for the purpose of enabling ID-bets about a social media system's content can be integrated into the social media system database, or the IDBS can be an outside service that the social media system interacts with.

Enabling a User to Create an ID-Bet and an ID-Bet Offer about an Entire Post

In this specification, a post means information that a user submits to a social media system as a single submission for other users to see. It is the information entered when a user “presses submit.” A post may be of arbitrary length.

A user may want to create an ID-bet about an entire post or about an excerpt within the post. The process for making an ID-bet for an entire post is described first.

A social media system's content creation functionality can include a “Create an ID-bet” and a “Make an ID-bet Offer” option to be employed when a user is creating a post.

When a user selects the “Create an ID-bet” option, the functionality enables a user to:
1. Identify the content she is creating as SI,
2. Identify the SI by a URL and/or a location in the social media system's database,
3. Create ID-bet terms, that is, create an IDBO,
4. Send that IDBO to the IDBS.

Likewise, when a user selects the “Make an ID-bet Offer” option, this functionality enables the user to easily make an ID-bet offer, that is, create an offer-object associated with the IDBO, and send the offer-object to the IDBS.

The social media system can also store a user's credentials (account information) for making ID-bet offers through the IDBS. Alternatively, the user's ID can be enough to submit an offer to the IDBS, if the user has an account with the IDBS.

Accordingly, in a preferred embodiment, the social media system's user interface includes an option for creating ID-bet terms when a user is in the process of creating content to post. The social media system includes software functionality that executes the following steps, when a user selects this option:
1. Stores, in temporary memory, the content being created as the SI of an ID-bet (this step may not be necessary if the SI is identified by a pointer to its location in the social media system's database),
2. Presents an input form to the user for setting the remaining ID-bet terms,
3. Registers and stores, in temporary memory, the user's selections of the remaining terms necessary to be set, thereby temporarily storing an IDBO,
4. Presents the user with the option of posting the content to other users, and simultaneously submitting the stored IDBO to the IDBS,
5. Upon the user selecting the “Submit Post and ID-bet Terms” option,
   a. Posts the content,
   b. In the IDBO, stores a pointer, such as a URL, to the location of the content in the social media system's database,
   c. Creates an identification number for the ID-bet terms and stores it in the IDBO,
   d. Adds an IDBO identification number to the IDBO,
   e. Adds a timestamp to the IDBO,
   f. Sends the IDBO to the IDBS,
   g. Receives a confirmation from the IDBS that the IDBO is stored,
   h. Presents the confirmation to the user,
   i. Displays selected IDBO terms along with the post,
   j. Along with the post, displays a link to the associated ID-bet market in the IDBS, enabling users to make ID-bet offers about the post.

For enabling the user to make an ID-bet offer, the social media system further:
7. Presents user with the option for making an ID-bet offer about the posted SI, according to the ID-bet terms set by the user,
8. Upon the user selecting the “Make Bet Offer” option, presents an offer input form 60,
9. Enters the user's bet offer information: outcome 61, odds (if any), and stake 62 and, optionally, a comment about the rationale for the offer, and stores this offer information in temporary memory as an offer-object,
10. Presents the user with the option to submit the offer-object to the IDBS,
11. Upon the user selecting the “Submit Offer” option:
   a. Adds the user's ID and betting credentials to the offer-object as the bettor ID,
   b. Adds an identification number to the offer-object,
   c. Adds association information (such as a database key) to the offer-object, relating it to the IDBO and relating it to the post,
   d. Adds a timestamp to the ID-bet object and the offer-object,
12. Sends the offer-object to the IDBS,
   a. Receives a confirmation from the IDBS that offer-object is stored,
   b. Presents the confirmation to the user,
   c. Displays the offer along with the post,
   d. Displays updated ID-bet market statistics,
13. Periodically, pulls selected ID-bet market statistics from the IDBS and displays these statistics along with the post.

In a preferred embodiment, the social media system's ID-betting functionality combines the process of creating the ID-bet and the process of making an offer about the SI of that ID-bet.

In practice, if social media systems with ID-betting functionality become popular, most ID-bet terms will likely be held standard so that social media systems enable common bets forms, which encourage more use. Where terms are standard, the IDBO can include an ID-bet class signifier denoting what standard terms and rules apply to the ID-bet.

Thus, as with a browser's ID-betting functionality, in a preferred embodiment, the social media system's user interface includes an option for “Making an ID-bet Offer” that enables the user to create bet terms and make a bet offer about a post, at the same time. The making of an offer on a post identifies that post as SI, which, if all other terms are held standard, is the only information that the user needs to supply to set the ID-bet terms.

As in the case of a browser with ID-betting functionality, a social media system's ID-betting functionality can include logic and interface options that enable a user to make and submit any kind of bet offer that the IDBS enables.

Enabling an ID-Bet Offer about an Excerpt

Rather than make an ID-bet offer about an entire post, a user might want to identify and bet about an excerpt. Thus, a social media system with ID-betting functionality will enable a bettor to select an excerpt on a page, create an ID-bet about the excerpt, and make an ID-bet offer about the excerpt. The social media system's user interface will include an option for enabling the user to choose “Whole Post” or “Excerpt” as the SI. The social media system enables a user who has selected “Excerpt” to select (“highlight”) the excerpt by any way that is well known in the art. The social media system stores a copy of the selected part of webpage, and stores a copy of that selection temporarily to be used as part of an IDBO.

Accordingly, when the user selects a portion of a post and then chooses the “Make an ID-bet About This Excerpt” option, the social media system executes these steps:
Store the excerpt in temporary memory to be part of an IDBO and an associated offer-object,
Store a copy of the selected excerpt in temporary memory to be part of the IDBO, as the SI of the ID-bet, and the SI of an associated ID-bet offer-object,
Associate the location of the post with the copy of the excerpt such that, together, these pieces of information identify the SI.

The rest of the steps are the same as above, the difference being that the copy of the excerpt has been added as the SI identifying information.

Whatever the particular procedure that the social media system employs for enabling a user to submit an IDBO and an ID-bet offer to the IDBS, the key steps for enabling an excerpt to be SI, are: (1) the social media system enabling the user to select the excerpt, (2) the social media system storing a copy, along with the location of the larger post, (3) associating these pieces of information to identify the excerpt as the SI of the user-created ID-bet, and the SI of the user's ID-bet offer.

Enabling a User to Create ID-Bet Terms and an ID-Bet Offer about Existing Content

The social media system's ID-betting functionality can include steps for enabling users to create ID-bet terms, and make ID-bet offers, about existing content. The processes are essentially the same as the steps above except that the content being stored as SI is not in the process of being created, it already exists. So, this functionality enables a user to select all or part of a post and identify that content as the SI of an ID-bet.

It is possible and convenient for the social media system's ID-betting functionality to include means for enabling the user to set the same ID-bet terms for all the ID-bet offers the user makes, that is, enable the user to set default ID-bet terms. In this case, a user would not have to select a Create ID-bet Terms option, but would only need to select a Make ID-Bet Offer option regarding any content that is selected to be the SI of an ID-bet offer.

Viewing Existing ID-Bets about a Post

If a social media system includes the capability to create ID-bets, it will include functionality for viewing those ID-bets. Accordingly, a social media system will include ID-bet viewing functionality that pulls current ID-bet market statistics for any post where an ID-bet has been created, and further displays a link to the ID-bet market, enabling users to make ID-bet offers about the SI in the post.

### Part 8

Word Processor with ID-Betting Functionality

Here disclosed is an improvement in word processors and related content creation tools, such as digital video editors. A word processor's features for creating content are improved by adding ID-betting functionality. With this functionality, a user can conveniently:
1. author the terms of an ID-bet about the content that the user creates,
2. make an ID-bet offer about that content,
3. embed those terms and that offer in the content,
4. submit the terms and the offer to an IDBS,
5. display those terms and that offer to consumers of the content.

With this functionality, a user can select multiple excerpts within the content (the document or file) and make separate ID-bet offers about each of them.

A word processor with ID-betting functionality can be device-based or cloud-based.

The word processor's ID-betting functionality can include logic means and interface options that enable a user to author any kind of ID-bet terms enabled by an IDBS, which the word processor interacts with.

To facilitate the making of an ID-bet offer to be stored in an IDBS, the word processor can store the user's credentials (account information) for making offers through the IDBS.

Enabling a User to Create an ID-Bet and an ID-Bet Offer about an Excerpt

With ID-betting functionality, a word processor's user interface will include a “Create an ID-bet” and a “Make an ID-bet Offer” option (which can be combined). These options can be employed when a user is a creating a document.

The word processor's ID-betting functionality will enable the user to select (highlight) an excerpt in a document and then select the Create an ID-bet option. When this option is selected, the word processor executes the following steps:
Presents a set of ID-bet classes for the user to select from (each class being recognized by the IDBS(s) that the ID-betting functionality interacts with),
When the user selects a class, creates an IDBO and stores the class identifier in it,
Stores or designates the user-selected excerpt as the SI of the IDBO,
Presents the user with a set of selections for specifying the remaining non-standard terms of the ID-bet (if any terms remain),
Stores the user's selections of terms in the IDBO,
Assigns and stores an identification number for the IDBO.

It is possible and convenient for the word processor's ID-betting functionality to enable the user to set the same ID-bet terms for all the ID-bet offers the user makes about excerpts in a document or documents. That is, the functionality can enable the user to set default ID-bet terms. In this case, a user would not have to select a Create ID-bet Terms option, but would only need to select a Make ID-bet Offer option regarding any excerpt that is selected to be the SI of an ID-bet offer.

In a preferred embodiment, the word processor's ID-betting functionality combines the process of creating ID-bet terms and the process of making an ID-bet offer. Thus, when the user selects the option to Create an ID-bet+Make an ID-bet Offer, or the Make an ID-bet Offer option, the word processor's ID-betting functionality further executes the following steps, to apply to the excerpt that the user has selected as the SI of the IDBO:
Presents an offer input form to the user for making an ID-bet offer about the SI, according to the terms of the IDBO class selected by the user,
Inputs the user's ID-bet offer information—outcome, odds (if any), and stake—and stores it in the document as an ID-bet offer-object, associated with the IDBO,
Adds to the offer-object:
   the user's betting credentials, recognized by the IDBS, as the bettor's ID,
   an identification number,
   association information relating the offer-object to the IDBO.

At this point, the document that the user is working on will have one or more stored IDBOs and offer-objects embedded within it. These objects are ineffective until they are sent (submitted) to an IDBS and stored in the IDBS, so users can view and act upon them.

Thus, the word processor's ID-betting functionality will include a feature for submitting stored IDBO's and ID-bet offer-objects to an IDBS. The word processor will include an interface element, e.g., a virtual button, that the user can select to submit IDBOs and ID-bet offers to the IDBS via an IDBS API.

Accordingly, when a document (file) is open, and the user selects the “Submit ID-Bet Offers” option, the word processor:
connects to the Internet,
sends the IDBO(s) and associated offer-object(s), stored in the document, to an IDBS, via an IDBS API or equivalent protocol,

The IDBS then:
stores the objects,
adds identification numbers to each,
sends confirmation and the identification numbers back to the word processor, via an API or equivalent protocol.

Depending upon implementation, the IDBS can create a link to each object and to the ID-bet markets created by the IDBOs and offer-objects, such that anyone who uses the links can view the information and make offers in the corresponding ID-bet market(s). If the IDBS creates links to the objects, it can send the links to the word processor.

If the word processor's ID-betting functionality receives the object identification numbers and/or links to the objects, the word processor will include logic means for storing that information in the corresponding document so that users viewing the document can use the identification numbers and/or links to access the corresponding IDBOs, the ID-bet offer objects, and ID-bet markets.

### Display of the ID-Bet Information

The word processor's ID-betting functionality can include an option for displaying each IDBO and ID-bet offer together with the corresponding excerpt. Displaying this information is analogous to displaying a footnote, a source, or a comment, associated with an excerpt.

With each excerpt, as noted, the display can include identification numbers or links to the IDBO, ID-bet object, and ID-bet market in the IDBS.

Additionally, the word processor can enable users to output a list of all the IDBO's and ID-bet offers stored in a document.

The display possibilities are highly variable.

IDBO and ID-Bet Market are not Necessarily Associated with a URL

If an IDBO is identified by an identification number in an IDBS, the IDBO and its SI are not necessarily associated with a URL. They may be associated with a URL, especially if the IDBS creates a URL for them. In any case, the IDBO with the associated SI, are an information entity existing in the IDBS, where users can view it, and make ID-bet offers according to its terms (assuming the IDBO bet question/event has not been settled, i.e., offers can still be made regarding the IDBO event).

Note, the IDBO and associated ID-bet market can also be found by any combination of information stored in the IDBO, such as the speaker name, title of the document, and the any other pieces of SI identifying information that are stored in the IDBO (see Part 1).

### Illustrative Example

As an example of how a word processor with ID-betting functionality would work, assume a document is being created about the economics of ethanol production. Assume the document has the statement, “Ethanol is produced with sugar in Brazil and with corn in the US.” The creator of the document could highlight this statement, select the “Create an ID-bet and Make an ID-bet Offer” option.

Assume the creator selects ID-bet terms that include two outcomes: ACCURATE and NOT ACCURATE. The creator could then input an ID-bet offer with, say, $500, staked on ACCURATE at even odds. The word processor would store this offer along with the rest of the information in an offer-object (see above) in the document.

Assume, further, that the offer-object is submitted to and stored in an IDBS, and that the IDBS has returned an identification number for the offer-object, and a link to the offer object, Assume the word processor incorporates these pieces of information into the document, and displays them along with the statement, possibly as a link or an icon.

Then, any person viewing the document can see the ID-bet offer displayed along with the statement, and can find the offer in the IDBS.

### Part 9

Email Sending System with ID-Betting Functionality

Here disclosed is an improvement in email sending systems. An email sending system's features for creating an email message are improved by adding ID-betting functionality. With this functionality, a user can conveniently (1) author the terms of an ID-bet about an email message that the user creates, (2) make an ID-bet offer about that message, (3) attach that offer to the email, (4) submit the ID-bet terms and the ID-bet offer to an IDBS, and (5) show the email recipient the ID-bet terms and ID-bet offer.

Adding an ID-bet offer to an email is analogous to digitally stamping the email with a certificate of sorts—an ID-bet offer stamp. An attached ID-bet offer might, for example, describe the email as ACCURATE.

If ID-bet offers are attached to emails, filtering software can be employed by recipients to screen the emails based on the attached ID-bet information (see Part 9).

An IDBO and an ID-bet offer-object do not have to be attached to an email in the conventional sense. Their information can be summarized and the objects can be identified by identification numbers and/or by links, enabling a recipient to look them up in the IDBS to see more detailed information.

Enabling a User to Create an ID-Bet and an ID-Bet Offer about an Entire Email

An email sending system has a user interface for creating email content—subject line, body content, and attachment(s). This interface can include “Create an ID-bet” and “Make an ID-bet Offer” options to be employed when a user is creating an email.

As in the case of a browser with ID-betting functionality, an email sending system's ID-betting functionality can include logic and interface options that enable a user to make and submit any kind of bet offer that the IDBS enables.

In a preferred embodiment, the emails system's ID-betting functionality combines the process of creating ID-bet terms and the process of making an ID-bet offer.

In practice, if email sending systems with ID-betting functionality become popular, most ID-bet terms will likely be standard. Standard terms mean that a user does not necessarily have to enter any information into the email system to set the terms of an ID-bet because the email content is the SI, and the rest of the terms are standard. All terms being standard is just one possibility, though. In practice, the email creation interface and logic means will likely enable a user to choose among different sets or types of ID-bet terms.

Assuming the terms are standard, the email system's user interface option for “Making an ID-bet Offer” will enable the user to create bet terms and make a bet offer about the email's content, at the same time.

In the description of the email sending system's ID-betting functions below, the assumption is that all the terms of an ID-bet are held standard, and that the content of the email is the SI.

And, the assumption is that, to facilitate the making of an ID-bet offer to be stored in an IDBS, the email system stores the user's credentials (account information) for making offers through the IDBS.

The email sending system's ID-betting functionality executes the following steps, when a user selects the Make an ID-bet Offer option to apply to the content that has been created by the user but not yet sent to the recipient:
1. Creates an IDBO in which it:
   a. stores the class of the ID-bet terms, the class being recognized by an IDBS, and representing the standard terms of the ID-bet,
   b. identifies the content of the email that user has created as the SI of the ID-bet terms,
   c. stores an identification number for the IDBO,
2. Presents an input form 63 to the user for making an ID-bet offer about the SI,
3. Inputs the user's bet offer information: outcome 64, odds (if any), and stake 65 and stores it in temporary memory as an ID-bet offer-object associated with the IDBO,
4. Adds to the offer-object:
   a. the user's betting credentials, recognized by the IDBS, as the bettor ID,
   b. an identification number,
   c. association information relating the offer-object to the IDBO,
5. Upon the user selecting the “Send” option in the email sending system's interface,
   a. sends the email to the recipient, including the IDBO and ID-bet offer object,
   b. sends a copy of the email to the IDBS, including the IDBO and ID-bet offer object,
6. IDBS upon receiving a copy of the email,
   a. Parses the email and attached objects,
   b. Stores the IDBO and offer-object,
   c. Stores the email content as the SI of the IDBO and offer-object,
   d. Creates database identification numbers for the IDBO and offer-object,
   e. Timestamps the receipt of the email and the IDBO and offer-object, and stores the timestamps in the objects,
   f. Creates a link to the ID-bet market formed by the IDBO and offer-object,
   g. Sends a confirmation to the email sending system that the IDBO and ID-bet offer are stored and that an ID-bet market has been created.

Instead of transmitting the IDBO and offer object via a copy of the email, the email sending system's functionality can transmit the same information to the IDBS via an IDBS API.

### Setting Default Terms

It is possible and convenient for the email system's ID-betting functionality to include means for enabling the user to set the same ID-bet terms for all the ID-bet offers the user makes, that is, enable the user to set default ID-bet terms. In this case, a user would not have to select a Create ID-bet Terms option, but would only need to select a Make ID-bet Offer option regarding any content in the email that is selected to be the SI of an ID-bet offer.

Getting a Link to the ID-Bet Market from the IDBS

A recipient of an email with an ID-bet offer attached can view all the information about the offer in the attachment, assuming the attachment provides all the information.

Alternatively, if only the basic ID-bet offer information, including an identification number, is sent, then the recipient will have to search the IDBS using the identification number, in order to find more detailed information.

Alternatively, the email sending system can include a link to the IDBO and the ID-bet offer, in the IDBS, that is, a link to the ID-bet market, in the IDBS, for the email content.

However, in order to send a link along with the email, the link first has to be created.

It can be created by the email sending system, if there is an established protocol for creating a link to a location in the IDBS database.

Alternatively, the email sending system can submit the email and attached IDBO and ID-bet offer to the IDBS, which can then store the information and return a link. The email sending system can then add the link to the email and then send the email to the recipient. In this scenario, the email goes to the IDBS first.

Alternatively, the IDBS can be an email relay system such that the email sending system sends the original email, including the IDBO and ID-bet offer-object and recipient address, to the IDBS which:
stores the IDBO and ID-bet offer-object,
creates a link to the corresponding ID-bet market,
adds the link to the email,
forwards the email to its intended recipient.

### Display of the ID-Bet Information

An email sending system with ID-betting functionality must display the ID-bet information in an email. The display can vary depending on implementation.

Most simply, the display can be a symbol and an identification number that denotes that an ID-bet offer has been made about the email content, and which enables the viewer to locate the offer in the IDBS.

Or, the display can be the key ID-bet offer information, i.e., the outcome/description the sender has staked money on, the amount of the stake, and the odds, if any. In this case, an identification number or link would be included with the email, to enable a recipient to see the full terms of the ID-bet and ID-bet offer.

The ID-bet information can be displayed on the subject line or on other equivalently prominent place in the email's display.

Alternatively, the IDBO and ID-bet offer can be included, partially or fully, in an attachment.

The display possibilities are highly variable.

Enabling a User to Create ID-Bet Terms and an ID-Bet Offer about an Excerpt

An email sending system's ID-betting functionality can enable a user to select an excerpt to make an ID-bet offer about. This functionality can enable more than one ID-bet offer to be made, each about a different excerpt, including about the subject line of the email.

To enable the user to bet about an excerpt, the email sending system's interface will include a Make an ID-Bet Offer About This Excerpt option. When a user chooses this option, the system enables the user to select an excerpt and then enter ID-bet offer information about it, which the system stores as an offer-object, as described above.

This option can enable a user to first select (“highlight”) the excerpt, and then choose the Make an ID-Bet Offer About This Excerpt action. The sequence is irrelevant.

Accordingly, when the user selects a portion of an email message and then chooses the “Make an ID-Bet About This Excerpt” option, the email sending system executes these steps:
Store the excerpt in temporary memory to be part of an IDBO and an associated offer-object,
Store a copy of the selected excerpt in temporary memory to be part of the IDBO, as the SI of the ID-bet, and the SI of an associated ID-bet offer-object,
Assign an identification number to the IDBO and the ID-bet offer-object to identify them to an IDBS.

The rest of the steps are the same as above, the difference being that the copy of the excerpt has been added to the IDBO as the SI identifying information.

### Part 10

Information Filtering Devices and Systems that Interact with the System

### Definitions

In Part 10 of this specification, the following definitions apply.

ID-bet data, ID-bet market data and ID-bet market statistics mean the same thing.

Online information source (source) means a device that sends information via the Internet to a receiving device. It can also mean a device that stores information, in which the information is found by information finding devices, such as search engines.

Information receiving device (receiver) means a device that receives information (a message) from an online source. A receiver can be controlled by a human end-user or not.

Online information filtering device (filter) means, but is not limited to, a combination of a computing device and software that (1) receives information from an online source, intended for a recipient, and (2) blocks some of that information from the recipient's receiving device or address, while allowing other information to pass. The filtering device can be software (an application) that runs on a receiver or it can be a separate device that passes information through to the receiver and/or recipient address.

Those skilled in the art know of many such filtering devices and software. They include browser-based filters, email filters, client side filters, network filters, DNS-based filters, search engine filters, firewalls, and virus and malware filters.

### Improvement in Online Filters

Here disclosed is an improvement in online information filtering devices and systems. Such devices and systems can be improved by including features for interacting with an IDBS and for using ID-bet data and ID-bet market statistics to filter information. ID-bet market statistics describe and label SI. If those statistics provide useful descriptions, they can be used to filter information.

### Online Message Filter Using an IDBS and ID-Bet Market Statistics

In a preferred embodiment described below, the source is an email server, the messages are email messages, and the filtering device is an email filter. Email messages in this embodiment represent other types of messages that are sent by an online server to a receiver, such as: text messages, VOIP (phone) messages, computer-to-computer push data feeds, and code sent for download. The filter's elements and operation are essentially the same for message types in which a server transmits digital messages to receivers.

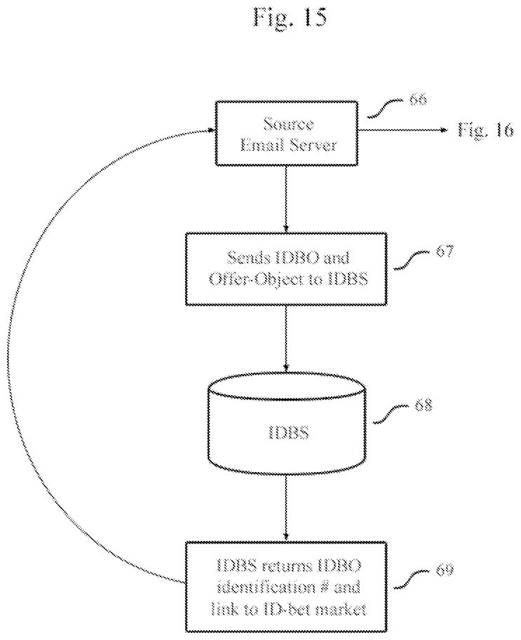

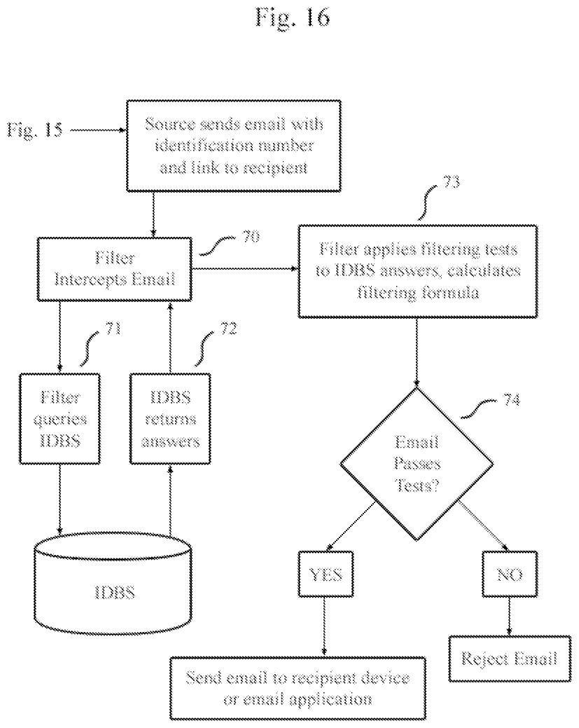

As shown in FIGS. 15 and 16, the email server 66 communicates with an IDBS 68, sends emails to a receiver and recipient address, while a filtering device 70 intercepts the email before it arrives at the recipient's email address.

This embodiment of the filtering process is simultaneously described in two ways. One way is as a system, in which an email server, an IDBS, and a filter perform actions sequentially, in stages. In the first stage, the email server, communicating with an IDBS, labels (“stamps”) an email with an ID-bet offer. But, it is not necessary to describe this first stage in order to describe the inventive filter. It can be assumed that an email has ID-bet information attached; there is no need to show the first stage. The first stage is described, though, because all three machines, operating in combination, can be considered an inventive system.

However, in practice, it is likely that the inventive filter will not have anything to do with email servers that add ID-bet information to emails. And so, the embodiment is also described as a hardware/software device that fits within a larger system.

ID-Bet Data Analysis Features Combined with Other Message Analysis Features

A filter with the ID-bet data analysis features described below can include other kinds of message analysis features that exist in current information filters. In practice, a filter with ID-bet data analysis features will likely include other message analysis features for screening messages. Thus, the inventive filter encompasses existing filters in combination with the ID-bet analysis features, elements, and filtering processes described here.

Elements of an Online Message Filter that Uses ID-Bet Information to Screen Messages

A message filter that uses ID-bet data will include some or all the following elements.
1. Input/output means for receiving a message, for querying an online database (especially an IDBS), and for passing the message to a recipient address.
2. Parser means for capturing the ID-bet information (IDBO or identifier, offer-object or identifier, and ID-bet market identifier) from the message, and storing this information in a structured way to be used in queries, filtering decision rules and scoring rules.
3. Query list for querying an IDBS using the ID-bet information captured from a message.
4. Filtering decision rules to apply to ID-bet data received from an IDBS to determine whether a message should be passed to a recipient address.
5. Scoring algorithm for evaluating ID-bet data received from an IDBS to determine whether a message should be passed to a recipient address. A filter will likely have more than one scoring algorithm, although it may only have one, depending upon the implementation. A scoring algorithm is not essential, since a filter can rely upon binary, filtering decision rules. Further, it's important to note that an online filter may rely on an outside service, or upon the IDBS, to score the ID-bet data for SI. Depending on implementation, the filter may then not have any scoring all, defaulting to using the scoring provided by an IDBS or of other outside service (see below).

Filtering decision rules and a scoring algorithms will foundationally depend on characterizations of the outcomes (descriptions of SI) that bettors have staked money on. A wide variety of such outcomes may exist, given that a wide variety of different ID-bet types and ID-bet terms may exist in the world. A characterization of an outcome/description means a judgment as to whether the description is “positive/good” or “negative/bad” (or the equivalent) about SI. The characterization can be a score or a binary judgement, e.g., ACCURATE is positive and NOT ACCURATE is negative. As a hypothetical example, on a scale of 1-100, ACCURATE might be 100 and NOT ACCURATE might be 1. A characterization can be a subjective judgment entered by a human system operator/programmer, or can be dynamically created by machine learning or other AI algorithms which track outcomes and message rejections by human users, over time. Just as machine learning and related techniques characterize words/phrases in message, to evaluate a message, these techniques can evaluate ID-bet data and characterize that data.

Stage 1—Labeling the Message (the Email) with an IDBO and an ID-Bet Offer

In the first stage of the system's process, the email server, under the direction of an operator:
creates an IDBO and associated ID-bet offer-object for an email message (see Part 9),
submits 67 the IDBO and offer-object to an IDBS 68.

The IDBS then:
stores the IDBO and offer-object,
creates unique identification numbers for them and, optionally, a link to each,
creates a unique identification number and/or a link to a corresponding ID-bet market that can be found in the IDBS (see Section 1.3),
sends 69 the identification numbers and the links, if any, to the email server.

The email server then:
attaches the IDBO, the ID-bet offer-object, and the ID-bet market identification number or link (rather than attach the full objects, the server may attach identification numbers for finding these objects, as discussed in Part 9),
sends the email to the address(es) of the intended recipient(s).

It is possible to send an email directly to a filtering device, to be forwarded to its ultimate address. In this specification, for simplicity, it is assumed that an email is sent to a recipient address and is “intercepted” by the filter.

Thus, in this first stage of the filtering process, an email has been virtually labelled (“stamped”) with an ID-bet offer and associated ID-bet market, before being sent to a recipient. At this point, the ID-bet market is only one offer, but that can change, especially if the email is sent to multiple recipients, each of whom can make an ID-bet offer in the market.

As a hypothetical example, an email message might be about an ulcerative colitis drug and the email server might attach an ID-bet offer in which the sender has staked $25,000 on the outcome ACCURATE at even odds, with an identification number IDBSxyzJQT371432.

### Stage 2—Filter Receives the Email and Parses Out the ID-Bet Information

In stage 2, the filtering device:
receives 70 the email
parses out the ID-bet information, such as identification numbers and/or links, enabling the filter to query the IDBS that allegedly stores the full set of ID-bet information,
stores the parsed ID-bet information.

### Stage 3—Filter Uses ID-Bet Information to Query an IDBS

In stage 3, the filtering device uses the ID-bet information to query 71 the IDBS where the information is allegedly stored (allegedly because the ID-bet information has not been validated; it could be faked).

Queries can include but are not limited to questions such as:
a. Does the alleged ID-bet offer exist in the IDBS?
b. Is the ID-bet offer information accurate?
c. Which outcome has the speaker and/or ID-bet author, staked money on?
d. How much money has the speaker staked?
e. What are all the ID-bet offers in the corresponding ID-bet market?
f. What are the current odds being offered by the speaker and/or ID-bet author?
g. What ID-bet rating does the speaker have (what is the speaker's ID-betting record)?

(As discussed in Part I, if ID-betting systems come to be popular, it's likely that statistical measures will be developed to rate speakers based on their ID-betting records. Ratings, similar to credit ratings, will likely be developed, and will likely be calculated in an IDBS for output to services, such as message filters.)

The filter receives answers 72 to the queries from the IDBS.

Stage 4—Filter Applies the ID-Bet Information and the IDBS Answers Using Decision Rules and/or Scoring Algorithm to Approve or Reject Emails

In stage 4, the filtering device uses the IDBS answers it receives, and the original ID-bet information it has received to apply 73 its decision rules, to approve or reject 74 the email.

These rules can include the tests below:
Does the ID-bet offer actually exist?
Is the speaker's money staked on an outcome characterized as good?
Is enough money staked on a good outcome?
Is the ratio of money staked on a good outcome versus a bad outcome high enough?
Is the ratio of the number of bettors staking money on a good outcome versus a bad outcome high enough?
Are the odds offered on a positively valued outcome/description greater than a threshold (that is, is the probability expressed in the odds greater than a threshold)?
Is the speaker's ID-bet rating high enough?

A decision rule could be, for instance: if the answer to any of these questions is no, reject the email. And, if the answer to all is yes, pass the email to the recipient address/inbox.

A scoring formula can be used, instead, in which the scoring formula uses the ID-bet answers it has received, and the original ID-bet information, to arrive at a score for the SI, that is, for the email. If the score is greater than a threshold, the filter lets the email through to the recipient's receiver/inbox.

### Using Scoring Formula Provided by an IDBS or Other Service

A simpler process, and one that is likely to be employed in practice, is to use scores provided by an IDBS or other scoring service.

In this process, the online filter executes the following steps:
Parse the email to find, at minimum, it's IDBO identity number or other equivalent identity number, for identifying the email in a scoring service database,
Send the identity number to the scoring service,
Receive a score back from the scoring service,
If the score is >threshold, send the email to the intended recipient device/inbox, and if the score is <threshold, block the email from the intended recipient device/inbox.
   Online Filter where the Content is Found in Sources the Internet

A source of information can be stored content, which is found by Internet search tools.

An online filter can use ID-bet data to discriminate between sources of information that are stored content.

This type of inventive filter, incorporated into different kinds of search devices and tools, is described in Part 11 of this specification.

### Part 11

Search Engine Components that Interact with the System

### Premise

If ID-bet market statistics are reliable descriptions of SI, they can be used by search engine systems to screen information for quality and relevance, to increase efficiency, and to enhance user satisfaction. As an illustration, assume the following:
(1) A query to a search engine is “Does black cohosh reduce hot flashes?”
(2) The search engine, in its index, finds links to 50,000 plausible answers, that is, to 50,000 relevant documents.
(3) 100 of those documents have associated ID-bet market statistics that describe those documents as ACCURATE.
(4) The other 49,900 documents have no associated ID-bet markets or have associated ID-bet market statistics that describe those documents as MISLEADING.
(5) The ID-bet market descriptions are reliable.

Given these assumptions, a search engine may only need to find and rank those 100 documents. Or, a search engine may simply spend more resources on finding and indexing content with positive market descriptions than on content with negative descriptions. Further, the quality of answers it provides may be better, on average, if it favors results with positive descriptions. And, if the descriptions are accurate, they can aid a search engine in finding relevant answers to queries. Thus, if ID-bet market signals are reliable and descriptive, search engine systems can be improved by including features that use those signals.

The general principle is that some of a search engine's key components give a higher weighting (or score) to content (SI) with a positive ID-bet market description, as defined by the search engine's algorithms, than the weighting they give to content with no ID-bet market description and to content with a negative ID-bet market description. The more positive the description, the higher the relative weighting.

### Components of a Search Engine System

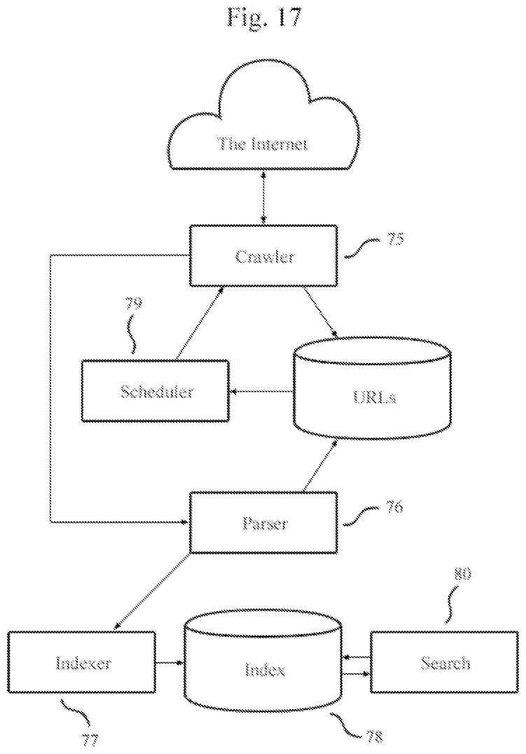

A search engine system has many parts, which can be divided in many ways. Here disclosed are improvements to the following components and combinations of components, shown in FIG. 17:
1. Web crawler 75, parser 76, indexer 77, and index 78
2. Web crawler scheduler 79, crawl frontier, and crawl decision policies
3. Indexer and index
4. Search results ranking algorithm 80

These components can be improved by adding features, described below, for downloading, storing, indexing, and using ID-bet data.

It should be noted that the component terms above are not precise; they refer to and encompass hardware/software devices and processes that are well known in the art. Descriptions of their functionality can be found, for instance, at https://en.wikipedia.org/wiki/Web_crawler, https://en.wikipedia.org/wiki/Crawl_frontier, and https://en.wikipedia.org/wiki/Search_engine_indexing, although these descriptions are not exhaustive and not meant to limit the inventive features disclosed here.

The components are grouped and combined according to their general functionality. The first grouping relates to the process of downloading content from the web, and storing a representation of it in an index. The second, third, and fourth groupings relate to a search engine system's functions for determining what information to download, store, and output.

For the purpose of this disclosure, the term search engine system encompasses web scraper systems and online directory systems because they all have key components in common.

### Improvements to a Search Engine Web Crawler, Parser, Indexer, and Index

A web crawler is software that finds web pages by following links and downloads information from those web pages. A parser is software that receives the information downloaded by a web crawler, decomposes it, structures it, and labels it for storage in a search engine index, or other database, or data structure, such as a repository of URLs. An indexer takes information from the parser and stores it in an index.

Disclosed are improvements to a web crawler, to a parser, to an indexer, to an index, and to the combination of all four. These processes and devices comprise the search engine system's chain for finding content on the web, downloading it, and storing it in an index to enable search results to be output.

All these components can be improved by including features for downloading, parsing, and storing ID-bet data about SI found at URLs (web pages).

The SI at a URL may be all the content at the URL, some excerpt(s), or both. As discussed above, multiple ID-bets may exist about multiple sets of SI on a web page. Thus, a web crawler can include functionality for downloading ID-bet data about all of the SI on a page.

The ID-bet data can be captured from a web page, if the web page code includes ID-bet data. Or, the ID-bet data can be retrieved from an IDBS via an IDBS API, which a web crawler can query before, after, or during the crawl of a URL.

ID-Bet Data that can be Downloaded and Used by the Web Crawler and Other Search Engine Components

The ID-bet data that can potentially be downloaded regarding SI includes all the ID-bet data described previously in this specification. This set of data can be used by all the search engine components listed above. So as not to repeat too much, the set includes, but is not limited to: the SI's associated IDBO, associated ID-bet offer-objects, associated ID-bet market statistics, and other relevant data that an IDBS has recorded about the specified SI, including SI identifying information (see Part 1). Additionally, other information related to the SI can be downloaded, especially bettor history statistics and speaker statistics (see Part 2). The set of ID-bet data and related statistics that are downloaded will depend upon the implementation. Rather than repeat the different types of ID-bet data that a web crawler can download, this specification incorporates the ID-bet data described in Part 1 (e.g., Section 1.6), Part 2, and Part 3. Regarding copies of the SI, described in Part 3, a web crawler can include functionality of downloading copies or pointers or links to copies. The ID-bet data described in all these Parts of the specification are not meant to limit the set of ID-bet data that can potentially be downloaded by a web crawler. The set will be determined by the IDBSs being queried, their datasets, and the particular implementations of the crawler and other search engine system components.

Where ID-Bet Data can be Downloaded from

If the ID-bet data is pulled from an IDBS, it is then combined or associated with the information downloaded from the URL being crawled. It may be combined by the crawler, by the parser, by the indexer, or by a separate process. In other words, the merge or association can be accomplished in various ways, as is clear to those skilled in the art.

For brevity, this specification assumes that the web crawler downloads ID-bet data from an IDBS, rather than from the web page being crawled. However, it is true that if a web page displays or includes ID-bet data in its code, it can potentially be more efficient to download the data from the page. Thus, a web crawler may do that. The downside of downloading from a web page is that the data may be old, incomplete, or fake. A crawler can also do both.

### Web Crawler Includes Functionality for Downloading ID-Bet Data

Accordingly, a search engine's web crawler and parser combination can include functionality for executing the following steps when downloading content from a URL:
Use the URL to query an IDBS for ID-bet data about SI at that URL,
If no ID-bet data is associated with that URL in the IDBS, record that fact,
If ID-bet data is received from the IDBS, pass that ID-bet data to a parser,
Parser:
   labels the ID-bet data,
   associates it with the URL,
   associates it with its corresponding SI,
   passes the ID-bet data to an indexer, such that the ID-bet data can be associated with the SI and the URL in the search engine's index,
the indexer passes the ID-bet data and associated URL to the index,
the index stores the URL and associates it with the ID-bet data.

Thus, in addition to a web crawler including functionality for downloading ID-bet data, a parser, indexer and index will all also include functionality for recognizing, processing, and storing that data, and associating it with its corresponding SI. Those skilled in the art will see many well-known methods for associating the content found on a web page with ID-bet data about that content. A URL alone may not be sufficient for identifying SI. The SI may need to be specified by a timestamp, for example, to distinguish it from other SI that can be associated with the URL (SI may change at a URL). And, SI that is an excerpt on a web page will need to be identified by more than just a URL.

In addition to sending ID-bet data to a parser to be indexed, a web crawler can send the data to a parser to be cached, or send it to another search engine module for caching.

As discussed above, sets of ID-bet data that a web crawler downloads, which the parser, indexer, and index then process, can be extensive. It can also be minimal—it will depend upon the implementation. It may be more efficient to download a small set of ID-bet data, which enables a search engine's results ranking algorithm to retrieve a larger set when necessary. Some examples are given below.
The ID-bet data that a web crawler downloads can be as simple as a flag that signifies whether an ID-bet market exists or not for content at the URL. A flag is useful because it tells other processes, such as a search results ranking algorithm, that ID-bet market statistics are available for specified URL content. Since ID-bet market statistics can change, it can be more efficient to store a flag, and retrieve ID-bet data about the content only when that data is needed.
The ID-bet data it downloads can be a quality score or an ID-bet data summary score for the SI found at a URL, the score being requested by the crawler and outputted by the IDBS. A quality/summary score can be useful because it is a compressed signal that describes the view of an ID-bet market about SI.
The ID-bet data it downloads can be pointers, unique identification numbers (record locators) or links to an IDBO and/or to an ID-bet market for given SI and/or to other ID-bet data described above. Pointers, record locators, and links may be more efficient storage-wise and enable the search engine ranking algorithm to find the corresponding ID-bet data when needed.
The ID-bet data that a web crawler downloads can be a set of ID-bet market statistics that the web crawler requests (probably via an IDBS API). A set of such statistics can be used by a search results ranking algorithm as factors to be used when calculating the rank of a search result within a list. As noted, examples of useful statistics that the web crawler can download are described in Part 1, Section 1.6. Each statistic or piece of data can be a valuable signal, depending on the search engine's algorithm for evaluating ID-bet data.

### Illustration of a Valuable Signal in ID-Bet Data

To illustrate how ID-bet data can be a useful signal, consider one piece of ID-bet data, the number of bettors involved in an ID-bet market, that is, whether it is a thin or thick market.

Continuing with the hypothetical query, “Does black cohosh reduce hot flashes?,” assume 100 documents have associated ID-bet markets with a positive description of the content in those documents. And, 99 of those documents have an associated ID-bet market with 10 or fewer bettors and less than $5,000 staked in aggregate on the outcome ACCURATE. And, further assume a single document has an associated market with 850 bettors, staking $2,000,000 in aggregate on ACCURATE, and 10 bettors staking $5,000 in aggregate on MISLEADING. This document's ID-bet market is called “thick” with lots of participants compared to the other “thin” markets. Having numerous bettors “voting” with a lot of money can be a signal of confidence that the description “ACCURATE” is reliable.

By analogy, one can compare this signal to the signal of a web page having a large number of backlinks pointing to it, the large number of links possibly being a signal of quality (U.S. Pat. No. 6,285,999). The larger the size of the ID-bet market, and the larger the amount of money on a description (outcome), and the larger the ratio of money on one description relative to the other possible descriptions, the stronger the signal, perhaps. Of course, the thickness of a market is just one signal.

The number of potentially strong signals is vast, especially given the permutations and the linear range of many of the signals, e.g., the amount of money staked on an outcome.

### Improvements to Web Crawler Scheduler, Crawl Frontier and Crawl Policies

A web crawler scheduler, a crawl frontier, and crawl policies are software, data structures, and data objects for directing a web crawler, telling it which URLs to crawl, and in what order. In this specification, these components will be treated as one—that is, they are the crawl decision-making modules and processes of a search engine system. For convenience in this specification, these modules/processes will be referred to collectively as a scheduler.

A scheduler dynamically builds and revises a crawl queue that gives a web crawler a list of URLs to crawl. A scheduler can also respond to a web crawler when the web crawler queries it to decide upon whether to crawl a site or go to a URL.

A scheduler has crawling policies, software encoded decision rules and conditions that the content or meta-content at a URL must meet (or not violate) in order for the URL to be put in a crawl queue by the scheduler.

Here disclosed are improvements to a scheduler. The basic idea is this: a scheduler can use ID-bet data about SI (content) at URLs to:
1. screen URLs with undesirable SI from being crawled.
2. rank URLs more effectively in a crawl queue.

The ID-bet data can, thus, enable the scheduler to more efficiently direct crawling and to raise the average quality of the URLs that are crawled.

As an illustration, assume three URLs:
URL A has no associated ID-bet market.
URL B has an associated ID-bet market that describes the SI at the URL as ACCURATE.
URL C has an associated ID-bet market that describes the SI at the URL as MISLEADING.

Assume the scheduler has no other information about these URLs. In this case, the scheduler, could apply its crawling policies to the ID-bet market data to possibly screen out URL 3 from being crawled.

Or, the scheduler, could apply its crawl ranking algorithm to rank the URLs in a crawl queue in the following order:
1. URL B
2. URL A
3. URL C

### Scheduler Suite of Policies Improved by Using ID-Bet Data

A scheduler's suite of policies can include policies for making decisions based upon ID-bet data associated with a URL. Such policies enable a scheduler to screen out URLs with SI (content) that has ID-bet market descriptions that violate a policy, that is, that do not meet the policy's selection criteria or condition(s) for crawling. For example, conditions that a policy can check for include, but are not limited to:
The outcomes (descriptions) that money is staked on
The number of bettors staking money on each outcome
The ratio of money staked on each outcome relative to the total money staked
The odds that bettors are offering on each outcome
Whether the ID-bet event is settled
The result of the ID-bet event, if any
Whether a URL has more than one ID-bet market associated with its content.

Accordingly, a scheduler with such policies, executes the following steps when evaluating whether or not to include a URL in a crawl schedule:
Apply ID-bet market statistics associated with a URL against crawl policy conditions,
If the statistics violate one or more of a policy's conditions, do not add the URL to the crawl queue.

### Scheduler Ranking Algorithm Improved by Using ID-Bet Data

A scheduler has a ranking algorithm that ranks URLs in an order to be crawled. This ranking algorithm can be improved by adding terms and functions that factor in ID-bet data, such that the results of the algorithm are a function of the ID-bet data.

Such an algorithm assigns positive values to certain outcome (description) choices by bettors, and negative values to other outcome choices by bettors. Positive and negative values are relative to each other, and can be expressed in a wide variety of ways.

In general, the algorithm can add positively to the score or weighting of a search result that has SI, depending on such factors as:
How much money is staked on a positive outcome
How many bettors have staked money on a positive outcome
The odds that bettors are offering for betting on a positive outcome
The amount of money staked on each outcome
How many bet offers are matched
How many bettors are betting on opposing outcomes
How many bettors have staked money on a negative outcome
The ratio(s) of the amounts of money staked on different outcomes
Whether the ID-bet event is settled
If the ID-bet event is settled, the result of the event
The bettors' history statistics associated with each bettor in an ID-bet market

The score or weighting can vary with any of these factors. For example, in general, the score or weighting given to a search result with SI will be higher as:
the more money is staked on a positive outcome relative to a negative outcome
the larger the number of bettors staking money on a positive outcome, relative to the number of bettors staking money on a negative outcome
the higher the odds offered on a positive outcome
the more successful (as defined by the algorithm) the bettors' records are for the bettors who are staking money on a positive outcome.

If a bet event is settled, with a positive outcome being chosen, generally, that would lead to a higher score or weighting, too.

The same logic applies in reverse for negative outcomes. In general, the score or weighting given to a search result will decrease as the money staked on a negative outcome increases relative to the money staked on a positive outcome.

As another example, if speaker statistics about the creator of the SI at a URL are available, those statistics can be factored into the ranking algorithm. For example, a speaker whose SI has never been found to be MISLEADING in an ID-bet event, and whose SI has ID-bet market descriptions that are predominantly ACCURATE, may get a higher score than a speaker whose SI has been found to be MISLEADING in many ID-bet events.

How a ranking algorithm uses ID-bet data will, of course, depend on the implementation.

Accordingly, a scheduler with a queue ranking algorithm can include code for executing the following steps when ranking a URL:
Feed the ID-bet data into the crawl schedule ranking algorithm,
Place the URL in the queue as directed by the ranking algorithm.

### Scheduler can Download ID-Bet Data

The description of improvements to a web crawler above, under the Sub-Heading “Web Crawler Includes Functionality for Downloading ID-Bet Data,” specified a set of steps that a web crawler can execute. Instead of, or in addition to, having a web crawler perform these functions, it is possible for a scheduler to perform them as it creates a crawl queue.

Accordingly, when a scheduler evaluates a URL to be crawled or not, it can execute the following steps:
Use the URL to query an IDBS for ID-bet data about SI at that URL,
If no ID-bet data is associated with that URL in the IDBS, record that fact,
If ID-bet data is received from the IDBS,
   Apply the ID-bet market statistics associated with the URL against crawl policy conditions,
   If the statistics pass the conditions,
      Feed the ID-bet data into the crawl schedule ranking algorithm,
      Place the URL in the queue according to the results of the algorithm.
      Pass that ID-bet data to a parser,
Parser:
   Labels the ID-bet data,
   Associates it with the URL,
   Associates it with its corresponding SI,
   Passes the ID-bet data to an indexer, such that the ID-bet data can be associated with the SI and the URL in the search engine's index,
Indexer passes the ID-bet data and associated URL to the index,
Index stores the URL and associates it with the ID-bet data.

In this version of the process, the SI (content) downloaded by the web crawler from the URL is associated with the ID-bet data in the search engine index. However, the ID-bet data may be stored in the index before the corresponding SI has been stored in the index. The association of these two sets of information—the SI and the ID-bet data in an index—can be accomplished in many ways, and in a different sequence, as is clear to those skilled in the art.

### Improvements to Search Engine Indexer and Index

Just as a scheduler can be improved by processes for using ID-bet data, so too can a search engine indexer and index.

An indexer will have features for processing ID-bet data and for storing it in an index.

A search engine index will have corresponding fields for storing the ID-bet data and associating it with corresponding URLs.

Further, the indexer can include policies—software encoded decision rules and conditions—for screening out SI with negative ID-bet market descriptions. These types of decision rules have been described above in Parts 10 and 11. The same type decision rules and conditions can be incorporated into an indexer.

Accordingly, an indexer can include features for processing and storing ID-bet data for a URL that execute the following steps:
Take ID-bet data associated with a URL,
Apply decision rules (conditions) to the ID-bet data to determine whether the SI found at the URL should be stored in the index,
If no, do not store a representation of the SI in the index.

### Improvements to Search Engine Ranking Algorithm

A search engine results ranking algorithm, or search algorithm, takes a user query, searches the search engine's index to find relevant results, and ranks those results for output.

Here disclosed are improvements to search result ranking algorithms, especially those that are used in public search engine systems that crawl and index content from the Internet.

If a search engine indexes content (SI) that has associated ID-bet market data, then a search engine's algorithm can be improved by adding functions and terms that factor in ID-bet data, such that the ranking of results is partly a function of the ID-bet data. Further, the algorithm can be improved by features that communicate with an IDBS, e.g. via an API.

In general, with these additions, a search algorithm adjusts the score or weighting of a search result depending on a variety of ID-bet data, as described above in “Scheduler Ranking Algorithm Improved by Using ID-Bet Data.” To repeat from that description, the algorithm assigns positive values to certain outcome (description) choices by bettors, and negative values to other outcome choices by bettors. Positive and negative values are relative to each other, and can be expressed in a variety of ways, and depend upon the implementation.

Another way of putting it is that a search algorithm can include terms and functions that, all other things being equal, assign a higher weighting or score to a URL that has SI with a positive ID-bet market description, than the weighting or score it assigns to a URL does not have SI, or that has SI with a negative ID-bet market description. In other words, the same URL with a “positive ID-bet market review” is scored more highly than the same URL without the review or the same URL with a negative review.

Accordingly, a search algorithm can include features and functions that use ID-bet data to calculate results rankings and that execute the following steps:
Take a user query,
Search the index for relevant results,
For each result that might be output to the user and that has associated ID-bet data in the index,
   Take the ID-bet data,
   Feed that ID-bet data into the ranking algorithm's functions for using ID-bet data to calculate the rank value of the result,
Run the ranking algorithm using the ID-bet data,
Output the ranked list of results.

However, the ID-bet data in the index may be old, may be a summary, or may just be a flag. Moreover, the search results found may not have ID-bet data associated with them in the search engine's index, and yet have ID-bet markets associated with them, maintained in an IDBS. Thus, the process above can be supplemented by additional features and steps for enabling the algorithm to request that an IDBS provide the current ID-bet market statistics for the URLs in a results list.

Accordingly, the algorithm, instead of outputting results can, after running the algorithm:
Store a list of tentative results,
Take the URLs of the tentative results,
Use the URLs as search terms to search an IDBS to find the current ID-bet data for those URLs,
Receive the current ID-bet data per URL from the IDBS,
   Feed the fresh ID-bet data into the algorithm's functions for using ID-bet data to calculate the value of each result,
Run the algorithm, re-ranking the tentative list of results,
If the re-ranked list is acceptable, output the results to the user,
If the re-ranked list is not acceptable, search the index again to find relevant results.

It is also possible that a search algorithm checks an IDBS in addition to its own index when first searching for results. Accordingly, a search algorithm can include features and functions that use ID-bet data to calculate results rankings and that execute the following steps:
Take a user query,
Search the search engine's index and an IDBS for relevant results,
If relevant results are found in the IDBS, put those results in a tentative output list along with the relevant results found in the search engine's index,
For the results found in the search engine's index, check the IDBS for current ID-bet data on those results,
Receive ID-bet data for those results or not from the IDBS,
Run the ranking algorithm on the results from the IDBS and from the search engine's index, and use the ID-bet data obtained from the IDBS in the calculation,
Output the ranked list to the user.

As described above, a search result score or weighting can vary with a wide variety of ID-bet data. How a search algorithm uses ID-bet data will depend on the implementation.

That said, in a preferred embodiment, the search algorithm will include functions that contribute to calculating a search result's ranking, and the functions will, in at least some cases, increase the score or weighting given to a search result as:
the ratio of money staked on a positive outcome to the money staked on a negative outcome increases
the amount of money staked on a positive outcome increases and no money is staked on a negative outcome
the ratio of bettors staking money on a positive outcome relative to the bettors staking money on a negative outcome increases
the number of bettors staking money on a positive outcome increases, and there are no bettors staking money on a negative outcome
the odds offered on a positive outcome increase.

And, in a preferred embodiment, if ID-bet data about a search result states that an ID-bet event has been decided regarding that search result, with a positive outcome chosen, the score or weighting given to the search result will increase relative to what it would be if the ID-bet event were not decided.

In a preferred embodiment, the logic and scoring work vice versa. That is, for example, the algorithm's functions will decrease the score or weighting given to a search result as the ratio of money staked on a negative outcome to the money staked on a positive outcome increases.

### A Search Algorithm can Include Features for Handling URL v URL ID-Bets

As described in Part 1, one type of ID-bet involves comparing the SI (content) at two URLs. In this case, if the search algorithm detects that such an ID-bet is associated with a search result URL, the first URL, the algorithm can execute the following steps:
find the second URL whose SI is being compared to the first URLs SI in the ID-bet,
find the ID-bet data associated with the second URL,
add the second URL to the list of tentative search results to be re-ranked,
run the ranking algorithm using the ID-bet data found for the search results in the tentative list,
output the ranked list to the user.

This type of ID-bet can be useful for search engine algorithms because it easily enables them to find relevant and potentially better search results. For example, assume that the user query is “Does black cohosh reduce hot flashes?,” and that a relevant article the search algorithm finds is at https://www.medicalnewstoday.com/articles/31.php. Assume, further, that there is an ID-bet about this article comparing it to a second article at https://www.ncbi.nlm.nih.gov/pubmed/1678292. And, assume the ID-bet event question is: which SI is MORE ACCURATE? Assume, finally, that $20,000 is staked by 20 bettors on the second article, and no money has been staked on the first article. In this hypothetical case, a search engine finding the first article would beneficially find the second article and rank it above the first, if that's what the ranking algorithm determines.

Enabling a User to Set a Preference for Content with Positive ID-Bet Descriptions

A search engine that ranks results using ID-bet data can also beneficially enable users to set a preference for results that have associated, positive ID-bet descriptions. Accordingly, a search engine can include features and functions that execute the following steps:
present user with the option to set a user preference for search results that are SI and that have positive ID-bet market descriptions,
store the user's preference in a user profile,
when the user enters a query, find matching results,
when calculating the search result rankings, increase the weightings and scores of results that have SI with positive ID-bet market descriptions, relative to results that are not SI, and relative to results that have SI with negative ID-bet market descriptions.

I claim:

1. an online bet transaction system for creating information describing bet (ID-bet) terms, for making ID-bet offers, and for transacting ID-bets, comprised of:
calculation and logic means for operating on information,
storage means for recording information,
input/output means,
communication transmission means for communicating over the Internet,
database means for storing, organizing, and retrieving information,
said system including the software modules for:
authoring the terms of an ID-bet about subject information,
finding and outputting said terms,
making an ID-bet offer,
creating and storing ID-bet data,
matching ID-bet offers,
determining the outcome of an ID-bet,
settling an ID-bet,
transferring money at stake according to said terms,
finding and outputting ID-bet data and ID-bet market statistics.

2. The system of claim 1 in which the system captures and stores a copy of the subject information.

3. The system of claim 1 in which users who have made ID-bet offers are alerted to changes in the associated subject information.
